(19) United States
(12) Patent Application Publication
(10) Pub. No.: US 2026/0288800 A1
(43) Pub. Date: Sep. 24, 2026

(54) SYSTEM

(71) Applicant: SoftBank Group Corp., Tokyo (JP)

(72) Inventor: Natsuki HASHIMOTO, Tokyo (JP)

(73) Assignee: SoftBank Group Corp., Tokyo (JP)

(21) Appl. No.: 19/560,234

(22) Filed: Mar. 9, 2026

(30) Foreign Application Priority Data
Mar. 19, 2025 (JP) 2025-044920

(51) Int. Cl. G06F 16/3329; G06F 16/35; G06F 40/284; G06V 40/16

(52) U.S. Cl. CPC G06F 16/33295; G06F 16/35; G06F 40/284; G06V 40/174

(57) ABSTRACT

A system includes a processor that is configured to: receive, via a user interface, attribute information and hobby information of a person whom a user is scheduled to meet; generate a prompt sentence based on the received attribute information and hobby information, the prompt sentence being used for instructing a generative artificial intelligence model to generate a response; and input the generated prompt sentence into the generative artificial intelligence model so that the model generates the response based on the prompt sentence.

### CROSS-REFERENCE TO RELATED APPLICATION

This application is based on and claims priority under 35 USC 119 from Japanese Patent Application No. 2025-044920 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for preparing users for a first-time meeting with another person are largely manual and depend on the user's own experience and intuition. Even when attribute information or hobby information of the person to be met is available, the user must manually interpret such information and imagine appropriate conversation topics, which is time-consuming and may lead to ineffective or awkward conversations. Furthermore, although generative artificial intelligence models are capable of producing natural language responses, there is no standardized mechanism for automatically converting the attribute information and hobby information of the person to be met into suitable prompts for such models in a way that systematically supports conversation preparation. As a result, users cannot easily obtain tailored conversational guidance that matches the characteristics of the person to be met and cannot efficiently grasp potential conversation points or common topics. The invention has been made in view of these circumstances, and an object of the invention is to provide a system that automatically generates prompts for a generative artificial intelligence model based on attribute information and hobby information of a person whom a user is scheduled to meet, and that provides the generated responses to the user as conversation support, thereby improving the efficiency and quality of conversation preparation.

### SUMMARY

In order to solve the above-described problems, according to one aspect of the invention, there is provided a system comprising a processor, wherein the processor is configured to receive, via a user interface, attribute information and hobby information of a person whom a user is scheduled to meet, generate a prompt sentence based on the received attribute information and hobby information, the prompt sentence being used for instructing a generative artificial intelligence model to generate a response, and input the generated prompt sentence into the generative artificial intelligence model so that the model generates the response based on the prompt sentence. The processor may be further configured to provide the generated response to the user visually or audibly, thereby enabling the user to directly view or listen to conversation examples or suggested topics tailored to the person to be met. The processor may be further configured to analyze the generated response using natural language processing techniques in order to identify conversation points and common topics based on the generated response, thereby extracting, organizing, and presenting key elements that are useful for actual conversation. By these means, the system can automatically transform the attribute information and hobby information of the person to be met into effective prompts, utilize a generative artificial intelligence model to produce appropriate responses, and present and analyze the responses so as to support the user's preparation for a first-time meeting in a systematic and efficient manner.
The term “system” refers to an arrangement including at least one hardware device, such as a server, computer, or terminal, that executes the processing described in the claims by means of a processor and associated components.
The term “processor” refers to a hardware processing unit, such as a central processing unit (CPU), microprocessor, or other computation device, that executes instructions to perform the functions recited in the claims.
The term “user interface” refers to a hardware and/or software interface, such as a graphical user interface on a display, a touch panel, a keyboard, a mouse, a microphone, or a combination thereof, through which a user can input information to and/or receive information from the system.
The term “user” refers to a human operator who utilizes the system, including providing attribute information and hobby information and receiving generated responses as conversation support.
The term “attribute information” refers to information indicating characteristics of a person whom the user is scheduled to meet, such as age group, occupation, personality traits, preferences, or similar descriptive properties.
The term “hobby information” refers to information indicating interests, leisure activities, or preferences of a person whom the user is scheduled to meet, such as favorite sports, music, movies, books, or pastimes.
The term “prompt sentence” refers to a text string or natural language instruction generated by the processor based on the attribute information and hobby information, the text string being intended to be input to a generative artificial intelligence model in order to specify or guide the content or style of a response to be generated.
The term “generative artificial intelligence model” refers to a software model, such as a neural network or language model, that is capable of generating natural language or similar content in response to an input prompt.
The term “response” refers to information output by the generative artificial intelligence model in accordance with the prompt sentence, the information typically being natural language text, and optionally including one or more suggested conversation examples, questions, or topics.
The term “visually” refers to providing information to the user in a form perceivable by sight, such as by displaying text, images, or graphical elements on a display device.
The term “audibly” refers to providing information to the user in a form perceivable by hearing, such as by outputting synthesized speech, recorded voice, or other audio through a speaker or headphones.
The term “natural language processing techniques” refers to computational methods and algorithms for analyzing, interpreting, and processing natural language text, including but not limited to tokenization, part-of-speech tagging, named entity recognition, topic extraction, and semantic analysis.
The term “conversation points” refers to specific items within the generated response that can serve as focal elements of a conversation, such as key questions, remarks, or ideas suitable for use in dialogue with the person whom the user is scheduled to meet.
The term “common topics” refers to subjects, themes, or interests that appear in the generated response and are likely to be shared between the user and the person whom the user is scheduled to meet, and that can therefore be used to facilitate or deepen conversation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

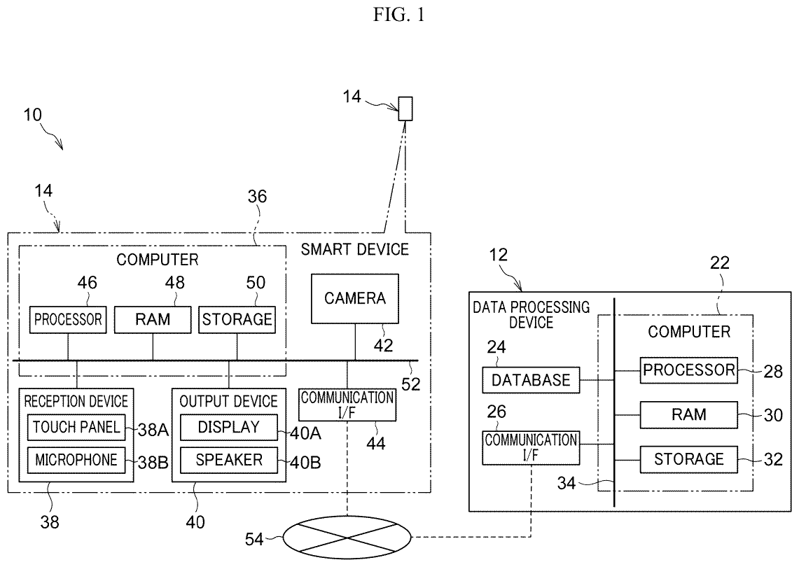

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

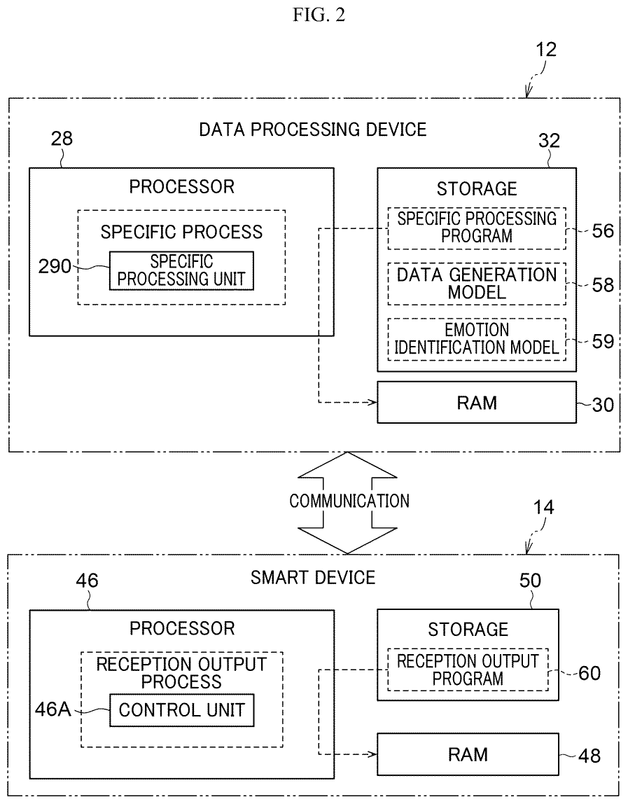

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented conversation support tools typically obtain a free-form description of a conversation counterpart and directly submit such description to a general-purpose generative AI model. In such approaches, a processor often passes unstructured text to the model without systematically constraining the input format, the requested output structure, or the safety conditions. As a result, the generated responses may be overly generic, incomplete, or inconsistent in structure, and may include content that is inappropriate for real-time conversation preparation. This leads to additional computational overhead on the client side or server side to manually filter, re-format, or re-interpret the model outputs, thereby reducing processing efficiency and responsiveness of the overall system.

Furthermore, conventional systems generally do not transform the user-provided attributes and preferences of the conversation counterpart into a machine-friendly, structured representation prior to constructing a prompt sentence. Without such structured data, it is difficult for the processor to programmatically generate prompt sentences that precisely reflect multiple attributes, output constraints, and behavioral guidelines for the generative AI model. This deficiency results in suboptimal control over the model behavior, and often requires repeated user interaction and manual editing of prompts, which degrades user experience and increases computational load due to multiple redundant model calls. In addition, known systems usually handle the text output of the generative AI model as a monolithic block of natural language. They do not perform systematic natural language processing on the response data to extract and classify topic candidates, question examples, utterance examples, and conversation-continuation expressions. Consequently, the system cannot take full advantage of the model's rich output in a structured manner, and cannot optimally generate user interface data such as lists or hierarchical views. This forces the user to manually scan, interpret, and mentally structure the generated text, which is inefficient and does not leverage the capabilities of modern computing devices to pre-process and organize information.

There is therefore a need for an improved computer-implemented system that: (i) acquires attribute and preference information of a conversation counterpart and converts it into structured data; (ii) automatically generates, from the structured data, a highly constrained prompt sentence suitable for a generative AI model, including explicit instructions, output formats, and restriction conditions; and (iii) applies systematic natural language processing to the model's response to extract and classify conversation-support elements, thereby generating structured display data. Such a system would improve the functioning of the computer itself by reducing unnecessary model calls, lowering client-side processing overhead, and enabling faster, more consistent generation and presentation of conversation support information.

The specific processing by the specific processing unit 290 of the data processing device 12 in Example 1 is realized by the following means.

The present invention provides a server comprising a processor and a memory storing instructions which, when executed by the processor, cause the processor to acquire attribute information or preference information regarding a conversation counterpart via a user interface including a general input/output device and store the attribute information or the preference information as structured data; automatically generate, based on the structured data, a prompt sentence suitable as input to a generative information processing model, the prompt sentence including instruction content for conversation support, an output format, prohibited matters, and a number of topic candidates, using a template, and format the prompt sentence as input data to the generative information processing model; transmit the formatted prompt sentence to the generative information processing model via a communication function, and obtain response data generated by the generative information processing model based on the prompt sentence; perform natural language processing on the obtained response data to extract topic candidates, utterance examples, question examples, and conversation-continuation expressions, and convert a result of the natural language processing into conversation support information that is presentable to a user; and output the conversation support information to the user via a display device or an audio output device. This enables the computer system to programmatically control the behavior of the generative AI model through structured prompt construction, reduce post-processing burden by extracting and organizing key conversational elements from the model output, and thereby improve processing efficiency, response consistency, and usability of conversation support functions implemented on general-purpose computing hardware.
The term “processor” refers to a hardware computation unit, such as a central processing unit or a graphics processing unit, that executes machine-readable instructions to perform data processing operations of the system.
The term “memory” refers to a hardware storage medium, such as a semiconductor memory or a magnetic storage device, that stores data and instructions executable by the processor.
The term “user interface” refers to a hardware and software combination, including at least one input device and at least one output device, through which a user provides information to the system and receives information from the system.
The term “general input/output device” refers to a hardware component, such as a touch-sensitive display, a keyboard, a pointing device, a microphone, a speaker, or a combination thereof, that enables a user to input data and receive output from the system.
The term “attribute information” refers to information representing characteristics of a conversation counterpart, including at least demographic characteristics, interest characteristics, or behavioral characteristics, that are relevant for generating conversation support.
The term “preference information” refers to information representing likes, dislikes, interests, or favored activities of a conversation counterpart that can be used to determine suitable conversation topics.
The term “conversation counterpart” refers to a person other than the user with whom the user intends to have a conversation and for whom conversation support is to be generated.
The term “structured data” refers to data arranged according to a predefined schema or format, such as key-value pairs, lists, or tables, that enables programmatic access, transformation, and storage by the processor.
The term “prompt sentence” refers to a natural-language or semi-structured text string that encodes instructions, constraints, and contextual information to be provided as input to a generative information processing model.
The term “generative information processing model” refers to a trained computational model, such as a neural network model, that receives an input sequence and automatically generates an output sequence including natural-language text based on learned statistical relationships.
The term “template” refers to a predefined text pattern or data structure that includes fixed portions and variable placeholders into which structured data is inserted to automatically construct the prompt sentence.
The term “instruction content for conversation support” refers to portions of the prompt sentence that direct the generative information processing model to generate information usable for preparing or conducting a conversation, including requested content types and behavioral guidelines.
The term “output format” refers to a specification included in the prompt sentence that indicates a desired structure of the model output, such as a list format, a numbered format, or a sectioned format.
The term “prohibited matters” refers to topics, expressions, or content categories that are designated in the prompt sentence as not to be included in the output of the generative information processing model.
The term “number of topic candidates” refers to a quantity or range specified in the prompt sentence that indicates how many distinct conversation topics are to be generated by the generative information processing model.
The term “communication function” refers to hardware and software components, including network interfaces and communication protocols, that enable data transmission between the server and the generative information processing model or another computing apparatus.
The term “response data” refers to digital data, including at least one text sequence, generated by the generative information processing model in response to the prompt sentence.
The term “natural language processing” refers to a set of computational techniques executed by the processor to analyze and transform human language text, including at least tokenization, segmentation, classification, or extraction.
The term “topic candidates” refers to elements derived from the response data that represent distinct subjects or themes suitable for discussion in a conversation.
The term “utterance examples” refers to example sentences or phrases derived from the response data that a user may speak or write during a conversation.
The term “question examples” refers to interrogative sentences or phrases derived from the response data that a user may use to ask questions in a conversation.
The term “conversation-continuation expressions” refers to phrases, sentences, or response patterns derived from the response data that assist the user in maintaining or extending a conversation once a topic has been initiated.
The term “conversation support information” refers to information generated by the system, including topic candidates, utterance examples, question examples, and conversation-continuation expressions, that is formatted for presentation to the user to aid in conversation preparation.
The term “display device” refers to a hardware component, such as a liquid crystal display or an organic light-emitting diode display, that visually presents information to the user.
The term “audio output device” refers to a hardware component, such as a speaker or an earphone, that converts digital audio signals into sound perceivable by the user.
The term “outline description” refers to a summary text describing general characteristics of the conversation counterpart, derived from attribute information or preference information and inserted into the prompt sentence.
The term “attitude conditions in the conversation” refers to instructions included in the prompt sentence that specify a desired tone, politeness level, or style of interaction, such as friendly, formal, or casual, for the generated output.
The term “output constraint conditions” refers to limitations or rules specified in the prompt sentence that constrain aspects of the generated output, such as length, style, language, or content boundaries.
The term “topic segments” refers to portions of the response data that each correspond to one of the topic candidates or a sub-topic thereof.
The term “topic type” refers to a classification label assigned to a topic segment, indicating a category such as entertainment, sports, work, or travel.
The term “speech act type” refers to a classification label assigned to a text portion indicating its communicative function, such as a question, a suggestion, a statement, or a greeting.
The term “expression tone” refers to a qualitative characterization of a text portion, such as formal, informal, polite, casual, or enthusiastic, that reflects the style of expression.
The term “display data” refers to data generated by the processor and formatted for direct rendering on a user interface, including layout structures, ordering, and grouping information for conversation support information.
The term “list format” refers to a presentation form in which conversation support information is arranged as discrete items in a sequence, such as bullet points or numbered entries.
The term “hierarchical structure format” refers to a presentation form in which conversation support information is arranged in multiple levels, such as parent topics and subordinate elements, enabling nested or grouped display on the user interface.

In one embodiment, a server cooperates with at least one terminal to provide conversation support information to a user preparing to meet a conversation counterpart. The server includes at least one processor, at least one memory storing machine-readable instructions and data structures, and at least one network interface. The terminal includes at least one processor, at least one memory, a display device, and at least one input device such as a touch-sensitive panel or a microphone. The user operates the terminal to input attribute information and preference information regarding the conversation counterpart, and the server executes a sequence of data processing operations to generate and present structured conversation support information based on a generative AI model.

The terminal executes an application implemented, for example, as a native mobile application using a framework such as an Android framework or an iOS framework, or as a web application rendered in a browser. The terminal provides a user interface including text input fields, selectable lists, and buttons. The user operates the terminal via a touch screen or other input device to input attribute information and preference information of the conversation counterpart, such as “likes baseball,” “enjoys live sports,” or “prefers casual conversation.” The terminal converts the raw input into structured data, for example, a set of key-value pairs maintained in memory as an internal object, and transmits the structured data to the server over a network using a communication protocol such as HTTPS.

The server executes a web application implemented using a general-purpose programming environment, such as a Python-based framework, a Java-based framework, or a JavaScript-based framework. The server receives the structured data via the network interface and stores the data in the memory in an intermediate representation. The server maintains a predefined schema for the structured data, such as a set of fields including at least “attribute_list,” “preference_list,” “language_setting,” and “output_style.” By enforcing this schema, the server prevents ambiguous free-text handling and enables deterministic processing paths, which improves processing efficiency and reduces parsing errors compared to conventional systems that forward unstructured text directly to a generative AI model.

The server uses a prompt-construction module to generate a prompt sentence for a generative AI model. The server stores a plurality of templates in the memory. Each template contains fixed text segments and placeholder tokens that are replaced with values from the structured data. The server selects an appropriate template based on the language setting and the desired output structure. The server performs string manipulation using deterministic string formatting operations, such as concatenation, placeholder substitution, and length limiting, to construct a prompt sentence that encodes both content context and output constraints.

For example, the server may generate the following prompt sentence for an English-language conversation counterpart who is a baseball fan:
“You are an assistant that helps users prepare for first-time conversations. The person I am going to meet is a baseball fan and enjoys watching live games at the stadium. Please list 7 specific conversation topics, each with: (1) a brief description of the topic, (2) 1-2 example questions I can ask, and (3) 1-2 example phrases I can say to continue the conversation. Use friendly, casual language and avoid political or other sensitive subjects.”

In another example, the server may generate a more general prompt sentence when the user has provided multiple attributes and preferences:
“You are an assistant that supports conversation preparation. The person I am going to meet likes music, enjoys baseball, and prefers relaxed, casual conversations. Please propose 5-7 concrete conversation topics that combine these interests, and for each topic provide: a short explanation, two example questions I can ask, and two short reply phrases I can say to keep the conversation going. Avoid technical jargon and controversial topics.”

The server formats the prompt sentence and associated parameters for a generative AI model. The server uses a generative information processing model implemented as a transformer-based neural network, such as a large language model. In one embodiment, the server employs a model comprising a stack of multiple self-attention layers and feed-forward layers, with learned parameters stored in a model parameter file accessible to the processor. The server converts the prompt sentence into a sequence of tokens using a deterministic tokenizer, such as a subword tokenizer, and passes the token sequence to the model along with decoding parameters such as maximum output length, temperature, and top-p sampling threshold. The server executes the generative AI model either locally on hardware with a graphics processing unit or via a remote model service over the network. When the server executes the model locally, the server loads the model weights into the memory and performs numerical matrix operations using a linear algebra library optimized for hardware acceleration. When the server uses a remote model service, the server transmits the prompt sentence and decoding parameters as request data and receives response data including at least one generated text sequence.

The server configures the generative AI model with a training procedure that refines the model specifically for conversation support. During training, the server uses training data composed of dialogues, conversation guidelines, and topic-structured examples. The server defines a loss function, for example a cross-entropy loss, computed between predicted tokens and ground truth tokens. The server updates model weights using an optimization algorithm such as stochastic gradient descent or an adaptive gradient method. The server may employ data augmentation techniques, such as paraphrasing or topic reordering, to increase training diversity and improve robustness. The server thereby obtains a model that is tuned to respond effectively to prompt sentences describing conversation counterparts and desired output structures.

The server uses the generative AI model in a way that is not a mere automation of human prompt-writing. The server applies a rule-based pre-processing and post-processing pipeline that interacts with the model to enforce structural consistency, reduce noise, and minimize redundant calls. The server's pre-processing pipeline analyzes the structured data and maps attributes to canonical categories using a lookup table or rules. The server assigns weights or priorities to each category and adjusts the prompt sentence accordingly, for instance by emphasizing certain interests or excluding irrelevant ones. This machine-driven adjustment improves the alignment between the user's input and the generative AI model's response, thereby reducing the need for repeated query attempts.

The server receives the response data from the generative AI model as a text sequence that may be formatted as a list, paragraphs, or sections. The server then executes a natural language processing module that further structures the response data. The server uses a tokenization algorithm to divide the response data into tokens and performs segmentation to identify text regions corresponding to different conversation topics. The server may identify topic boundaries by searching for numbering patterns, bullet markers, or specific connective expressions. The server classifies each segment based on topic type, speech act type, and expression tone by applying rule-based classification or by using lightweight classifier models that have been trained on labeled conversation-support data.

The server converts the classified segments into conversation support information stored in the memory as a structured object. For each topic, the server records fields such as “topic_title,” “topic_description,” “question_examples,” and “continuation_phrases.” The server normalizes the text by removing redundant prefixes, harmonizing punctuation, and truncating excessively long segments. The server also performs safety filtering by checking the text against content rules stored in memory, such as lists of prohibited terms or regular expression patterns for sensitive content. This multi-stage processing flow transforms the raw model output into a structured, safe, and compact representation, which reduces the data amount transmitted to the terminal and enables efficient rendering on the display device. The terminal receives the structured conversation support information from the server and converts it into display data for presentation. The terminal maps the structured fields to graphical user interface elements, such as list items, expandable sections, and labels. The terminal uses a UI framework component (for example, a list or table component) to render the topics in a scrollable view. The terminal may also provide interaction elements, such as checkboxes or favorite buttons, associated with each topic or example phrase. The user views the displayed information and may select particular topics or phrases to store locally in the terminal memory for later reference. The terminal may use local storage systems, such as a database or key-value store, to persist the selected information.

The described configuration produces a technical effect beyond automation of human mental steps. The server reduces communication load by transmitting compact structured data instead of large unconstrained text blocks. The server improves processing speed and responsiveness by generating a single, well-structured prompt sentence that yields highly usable structured output, thereby reducing the number of iterative model calls and limiting server-side and network resource consumption. The server improves the accuracy and consistency of conversation support information by enforcing explicit output structures, performing classification and filtering, and encoding user-specified constraints directly into the prompt sentence and post-processing pipeline. This arrangement improves the functioning of the computer system as a whole, including more efficient memory utilization, reduced unnecessary computation, and enhanced control over generative model behavior.

The server applies unique processing rules that differ from human reasoning procedures. The server formalizes attributes and preferences into canonical codes and uses those codes as features to construct prompt sentences according to deterministic algorithms. The server assigns priority scores to attribute categories and modifies the template selection, instruction content, and requested number of topic candidates based on these scores. The server's natural language processing module treats the model response as raw data for further machine classification and segmentation instead of final end-user content. This additional machine-centric structuring and validation step reduces noise and increases signal quality, which directly supports faster rendering by the terminal and easier interaction on resource-constrained devices.

In an alternative embodiment, the server executes the generative AI model on a dedicated hardware accelerator and performs batch processing of prompt sentences for multiple users. The server groups multiple prompt sentences with similar structure and jointly processes them in a single batch forward pass through the model. This batching reduces redundant loading of model parameters and reuses intermediate computations within the transformer architecture, thereby improving throughput and lowering latency. The server may also compress prompt sentences or model outputs using a compression algorithm before network transmission, further reducing communication load.

In another embodiment, the server employs different prompt templates depending on the intended use context, such as professional meetings versus casual social interactions. The server stores multiple template sets and selects a set based on a context parameter provided by the terminal. The same structured data encoding of attributes and preferences can thus be reused with different template sets, enabling flexible generation of context-specific instruction content without modifying the core data structures or model configuration. This modular design facilitates extension of the system to additional conversation domains and languages while maintaining the technical advantages of structured prompt construction and post-processing.

In yet another embodiment, the server records historical usage data, including which topic candidates and example phrases were frequently marked as useful or saved by the user. The server analyzes this usage data using statistical analysis or a lightweight ranking model and modifies future prompt sentences to prioritize attributes and output styles that historically yielded higher user engagement. By adapting the prompt-construction rules to empirical feedback, the server improves the expected utility of each model call and further reduces redundant requests. This adaptive behavior enhances computational efficiency at the system level, because the server requires fewer generative AI model invocations to obtain satisfactory conversation support information.

The described embodiments can be implemented on various hardware configurations and software platforms. The server may be implemented as a cloud-hosted application distributed across multiple computing nodes, each executing the described modules. The terminal may be a smartphone, a tablet, a personal computer, or a dedicated communication device. The system can also be extended to support voice-based interfaces, where the terminal converts user speech into text using a speech recognition module and outputs conversation support information via speech synthesis, while retaining the same internal structured data model and prompt construction mechanisms at the server.

As a result, the system described herein provides a concrete technical implementation that combines structured attribute and preference encoding, template-based prompt sentence construction, transformer-based generative AI modeling, and structured post-processing via natural language processing. The cooperation of the server and the terminal in this architecture yields improved computational efficiency, reduced network load, and enhanced control over generative output, thereby improving the performance and functionality of general-purpose computing equipment in the field of conversation support.

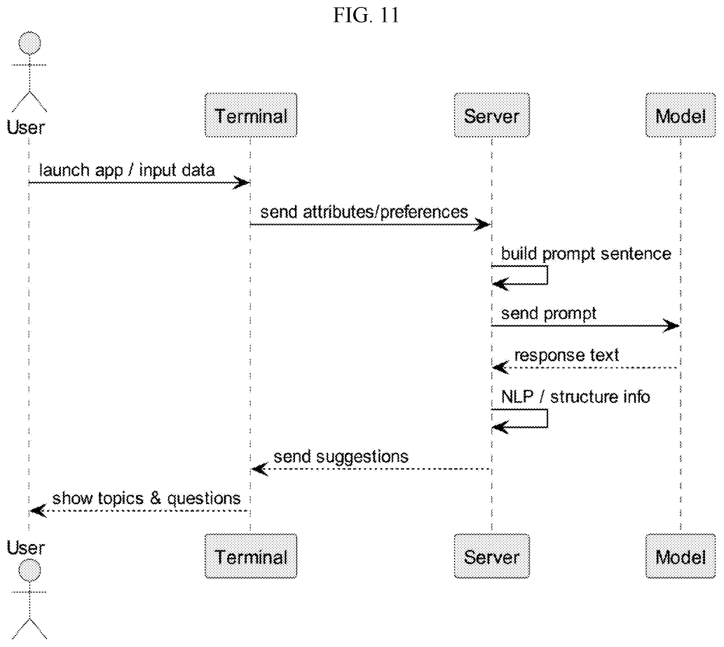

The following describes the processing flow using FIG. 11.

### Step 1:

The user operates the terminal to launch a conversation-support application and open an input screen for a conversation counterpart.
The input of Step 1 is a user action of starting the application on the terminal.
The terminal loads application resources from local storage into memory, initializes user interface components such as text boxes, dropdown lists, and buttons, and allocates data structures to store attribute information and preference information.
The output of Step 1 is an active user interface on the terminal that is ready to receive attribute information and preference information regarding the conversation counterpart.

### Step 2:

The user operates the terminal to input attribute information and preference information of the conversation counterpart through the user interface.
The input of Step 2 is user keystrokes, touch selections, or voice input captured by the terminal's input devices.
The terminal converts low-level input events into text strings and selected codes, normalizes the text by trimming spaces and unifying character encoding, and stores the normalized values into temporary variables representing attributes and preferences.
The output of Step 2 is a set of raw attribute values and preference values held in the terminal memory.

### Step 3:

The terminal structures the raw attribute values and preference values into a predefined internal data object.
The input of Step 3 is the set of raw attribute values and preference values produced in Step 2.
The terminal maps each text value to a specific field of an internal schema, for example mapping “baseball fan” to an element of an attribute_list field and mapping “enjoys live games” to an element of a preference_list field, and verifies that mandatory fields are not empty by executing validation logic.
The output of Step 3 is a structured data object, for example a record containing attribute_list, preference_list, language_setting, and context_type fields.

### Step 4:

The terminal transmits the structured data object to the server via a communication interface. The input of Step 4 is the structured data object generated in Step 3.
The terminal serializes the structured data into a transmission format, attaches it to a network request addressed to a server endpoint, and sends the request over a network connection using a protocol such as HTTPS.
The output of Step 4 is a network message containing the structured attribute information and preference information that is delivered to the server.

### Step 5:

The server receives the network message and reconstructs the structured data object in server memory.
The input of Step 5 is the network message transmitted by the terminal in Step 4.
The server decodes the received message, parses the payload using a parser corresponding to the transmission format, and maps the parsed values into a server-side structured data object that conforms to the same schema as used by the terminal.
The output of Step 5 is a server-side structured data object containing attribute_list, preference_list, and related fields.

### Step 6:

The server normalizes and categorizes the attribute_list and preference_list to obtain canonical representations.
The input of Step 6 is the structured data object generated in Step 5.
The server compares each attribute string and preference string against a stored dictionary of known categories, assigns a canonical code to each recognized item, and performs data processing such as lowercasing, synonym replacement, and removal of redundant descriptors.
The output of Step 6 is a canonicalized data object that includes both original text values and corresponding category codes for each attribute and preference.

### Step 7:

The server selects a prompt template and computes parameter values for constructing a prompt sentence.
The input of Step 7 is the canonicalized data object from Step 6 and configuration data stored in server memory.
The server evaluates rules that consider the number of attributes, the types of preferences, the language_setting, and the context_type, and selects one template from a set of stored templates; the server also calculates parameters such as the requested number of topic candidates, a desired output format, and prohibited content categories.
The output of Step 7 is a selected template identifier and a parameter set that jointly define how the prompt sentence will be constructed.

### Step 8:

The server generates a prompt sentence by inserting attribute information, preference information, and instruction parameters into the selected template.
The input of Step 8 is the selected template identifier and parameter set from Step 7, together with the canonicalized data object from Step 6.
The server executes deterministic string operations such as placeholder substitution, concatenation, and line-break insertion to assemble a natural-language prompt sentence that combines an outline description of the conversation counterpart, explicit instructions for conversation support, and structural constraints for the generative AI model.
The output of Step 8 is a completed prompt sentence ready for submission to the generative AI model, for example:
“You are an assistant that helps users prepare for first-time conversations. The person I am going to meet is a baseball fan and enjoys watching live games at the stadium. Please list 7 specific conversation topics, each with: (1) a brief description of the topic, (2) 1-2 example questions I can ask, and (3) 1-2 example phrases I can say to continue the conversation. Use friendly, casual language and avoid political or other sensitive subjects.”

### Step 9:

The server formats the prompt sentence and associated decoding parameters as input data for a generative AI model.
The input of Step 9 is the prompt sentence produced in Step 8 and system settings related to model selection and decoding behavior.
The server tokenizes the prompt sentence into a sequence of token identifiers using a tokenizer associated with the generative AI model, attaches configuration values such as maximum token count, temperature, and sampling thresholds, and constructs a model input structure that conforms to the generative AI model interface.
The output of Step 9 is a model input structure containing tokenized prompt data and decoding parameters.

### Step 10:

The server executes or invokes the generative AI model using the model input structure.
The input of Step 10 is the model input structure created in Step 9.
The server passes the token sequence and decoding parameters into a transformer-based neural network that performs matrix multiplications, attention weight calculations, nonlinear activations, and layer-to-layer propagation to produce probability distributions over output tokens, and selects output tokens according to the decoding strategy until a termination condition is met.
The output of Step 10 is raw response data from the generative AI model, typically in the form of a generated text sequence representing conversation topics, example questions, and example phrases.

### Step 11:

The server segments the raw response data into topic-level units and classifies each segment.
The input of Step 11 is the generated text sequence obtained in Step 10.
The server tokenizes the generated text, searches for markers such as line breaks, numerals, or bullet-like prefixes, and divides the text into segments corresponding to individual topics; the server then applies rule-based or model-based classification to each segment to assign labels for topic type, speech act type, and expression tone.
The output of Step 11 is a list of labeled segments, each segment containing a text portion and associated classification labels.

### Step 12:

The server extracts structured conversation support elements from the labeled segments.
The input of Step 12 is the list of labeled segments from Step 11.
The server determines, for each labeled segment, which text portions represent topic descriptions, which portions represent question examples, and which portions represent conversation-continuation expressions, and constructs a structured record for each topic that contains fields such as topic_title, topic_description, question_examples, and continuation_phrases.
The output of Step 12 is a structured conversation support object containing multiple topic records with clearly separated fields.

### Step 13:

The server performs normalization and safety filtering on the structured conversation support object.
The input of Step 13 is the structured conversation support object produced in Step 12.
The server truncates text fields that exceed predetermined length limits, removes repeated or irrelevant sentences, checks each field against content rules and prohibited word lists, and deletes or replaces any portion that violates safety criteria.
The output of Step 13 is a cleaned and safe conversation support object suitable for presentation to the user.

### Step 14:

The server compresses and packages the conversation support object for transmission to the terminal.
The input of Step 14 is the cleaned conversation support object from Step 13.
The server converts the object into a compact representation by removing auxiliary metadata, optionally applying a compression algorithm, and embedding the resulting data into a response message for delivery over the network.
The output of Step 14 is a network response message containing compressed and structured conversation support information.

### Step 15:

The terminal receives the response message and reconstructs the conversation support object locally.
The input of Step 15 is the response message transmitted by the server in Step 14.
The terminal decodes the message, decompresses the data if compression was applied, and maps the received values into a terminal-side data structure that mirrors the structure of the conversation support object stored on the server.
The output of Step 15 is a local conversation support object in the terminal memory, ready for display.

### Step 16:

The terminal renders the conversation support information on the display device for the user.
The input of Step 16 is the local conversation support object generated in Step 15.
The terminal iterates over topic records, generates graphical elements such as list entries and expandable sections for each topic, binds textual fields to labels, and draws these elements on the display using a user interface framework, optionally enabling user interaction elements such as selection buttons or scroll gestures.
The output of Step 16 is a visual representation of topics, question examples, and conversation-continuation expressions visible to the user on the terminal display.

### Step 17:

The user reviews the displayed conversation support information and may select specific items for storage or reuse.
The input of Step 17 is the rendered user interface showing the conversation support information.
The user taps or otherwise selects particular topics or phrases on the terminal, and the terminal interprets these interactions as selection commands and updates an internal list of saved items in local storage.
The output of Step 17 is an updated set of saved conversation support items associated with the user, which can be reused in future sessions without re-requesting identical information from the server.

### Step 18:

The server optionally logs anonymized processing metrics to improve future prompt generation and model usage.
The input of Step 18 is metadata derived from the conversation support object, such as counts of selected items and types of topics generated.
The server aggregates these metrics in a log storage subsystem, performs statistical calculations such as frequency counts or average selection rates for topic types, and updates configuration parameters that influence template selection and parameter values in future prompt sentence generation.
The output of Step 18 is an updated configuration state on the server that can lead to more efficient and accurate prompt sentence construction and generative AI model calls in subsequent executions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems and communication-support tools are not optimized to transform high-level, informal attribute and preference descriptions into concrete, context-aware product proposals in real time at the point of use. In many retail and face-to-face interaction scenarios, a user such as a salesperson must manually interpret a person's hobbies and attributes, mentally formulate queries, and search for relevant items using generic search interfaces. This process is cognitively demanding, slow, and often inconsistent, resulting in suboptimal use of computing resources and poor utilization of available data.

Existing systems typically treat user-entered attributes and preferences as unstructured text or as simple filter parameters, and do not provide an integrated processing pipeline that (i) acquires such information at a terminal, (ii) automatically converts the information into an optimized prompt sentence for a generative AI model at a server, (iii) converts the model's free-form text output into a structured, machine-usable product proposal representation, and (iv) controls terminal-side presentation so that a user can directly operationalize the proposals during live interaction. As a result, server and terminal resources are not effectively coordinated, the generative AI model is not efficiently driven by structured context, and the user interface logic is decoupled from the underlying data transformations.

Furthermore, in conventional architectures, significant manual effort is required to interpret the generative model's raw text output and to map it to specific attributes and preferences. This manual mapping introduces latency and errors, prevents scalable deployment in fast-paced environments such as physical stores, and fails to leverage the terminal display subsystem as an active component of the recommendation workflow. In particular, existing approaches do not provide a technical mechanism by which the server systematically transforms generative output into structured multi-item product proposal data including names, classifications, and reasons, nor a mechanism by which the terminal emphasizes or segments the proposals in correspondence with the original attributes and preferences to reduce user cognitive load.

Accordingly, there is a need for a computer-implemented technique that improves the way server-side processing, generative AI model invocation, and terminal-side display processing are coordinated. Such a technique should provide a concrete data-processing pipeline that begins with structured acquisition of attribute and preference information, generates an optimized prompt sentence for a generative AI model, converts the model's response into structured proposal data, and presents that data in a manner that directly supports decision-making at the user interface. By doing so, the system can improve the efficiency, reliability, and technical performance of computer resources used for personalized product proposal generation and presentation.

The specific processing by the specific processing unit 290 of the data processing device 12 in Application Example 1 is realized by the following means.

The present invention provides a server comprising a processor and a memory storing instructions that, when executed by the processor, cause the processor to receive, from a terminal via a communication interface, structured text data representing attribute information and preference information of a person to be met that has been acquired and stored at the terminal, generate, based on the structured text data, a prompt sentence expressed in natural language for a generative AI model and construct a generation request including the prompt sentence, transmit the generation request to the generative AI model via a network interface, obtain response data including product proposal information generated by the generative AI model based on the prompt sentence, convert the response data from free-form text data into structured data including a plurality of proposal items each having associated name information, classification information, and reason information, and transmit the structured data to the terminal for display on a visual display device in a list or itemized format with emphasis or segmentation indicating correspondence between the product proposal information and the attribute information and the preference information. This enables a technically improved data-processing pipeline in which server-side components automatically transform user-provided attributes and preferences into an optimized prompt sentence for a generative AI model, convert the model's response into machine-usable structured product proposal data, and cooperate with terminal-side display control to reduce user cognitive load and latency, thereby enhancing the overall efficiency, reliability, and practical usability of computer systems for generating and presenting personalized product proposals.
The term “processor” refers to a hardware execution unit, such as a central processing unit or a processing core, that executes computer-readable instructions to perform data processing operations.
The term “memory” refers to a hardware storage component, such as volatile memory or non-volatile memory, that stores computer-readable instructions and data for access by a processor.
The term “terminal” refers to an information processing apparatus, such as a portable computing device or a display-equipped client device, that provides a user interface for inputting information and for presenting output information to a user.
The term “server” refers to an information processing apparatus or system, typically connected to a communication network, that receives data from a terminal, executes processing including communication with a generative AI model, and returns processed data to the terminal.
The term “user interface” refers to a software-controlled input and output mechanism, such as a graphical user interface or a voice-based interface, through which a user inputs information and receives information from the system.
The term “attribute information” refers to information indicating characteristics of a person to be met, including but not limited to demographic characteristics, interest categories, or other profile-related descriptors.
The term “preference information” refers to information indicating likes, dislikes, hobbies, or interests of a person to be met, expressed, for example, as text labels or descriptive phrases.
The term “structured text data” refers to text-based data that is organized according to a predetermined format, such as key-value pairs or arrays, enabling systematic parsing and processing by a computer.
The term “storage area of a terminal” refers to a logical or physical memory region within the terminal, such as an internal memory area or an application data store, in which data is stored for processing or later transmission.
The term “prompt sentence” refers to a natural-language text expression generated based on attribute information and preference information, and configured to be supplied as input to a generative AI model to cause the generative AI model to generate a response.
The term “generative AI model” refers to a machine learning model, such as a neural network-based language model, that generates output data including text in response to input data, such as a prompt sentence, according to statistical patterns learned from training data.
The term “generation request” refers to a data structure or message including at least a prompt sentence and optionally one or more control parameters, which is transmitted from the server to the generative AI model to request generation of output data.
The term “response data” refers to data received from the generative AI model in reply to a generation request, the data including at least text corresponding to output generated based on the prompt sentence.
The term “product proposal information” refers to information indicating one or more recommended products or services, including at least an identification of each recommended item and an associated explanation or justification.
The term “predetermined data structure” refers to a defined format, such as a list, table, or object structure, for representing product proposal information so that it can be programmatically accessed and displayed by the terminal.
The term “visual display device” refers to a hardware display component, such as a display panel, a monitor, or a head-mounted display, capable of visually presenting information to a user.
The term “list format” refers to a display format in which multiple items of information are presented as a sequence of entries, such as a vertical list or a numbered list, enabling a user to view and compare the items.
The term “itemized format” refers to a display format in which information is divided into discrete items or sections, each corresponding to a particular proposal or element of data.
The term “structured data” refers to data organized into a defined schema, such as a set of records or objects with named fields, to facilitate programmatic manipulation and retrieval by a computer system.
The term “proposal item” refers to an individual unit of product proposal information within structured data, representing a single recommended product or service together with associated details.
The term “name information” refers to information that identifies a proposal item by a human-readable label, such as a product name or a generic designation.
The term “classification information” refers to information that indicates a category, type, or group to which a proposal item belongs, such as a product category or functional classification.
The term “reason information” refers to information describing why a particular proposal item is recommended, for example by relating the proposal item to at least part of the attribute information or the preference information.
The term “correspondence” refers to an association or mapping relationship between elements of product proposal information and elements of attribute information or preference information, indicating how proposals relate to user-provided context.
The term “emphasize” refers to visually highlighting information on a display screen, for example by changing color, size, position, or style, to draw a user's attention to particular content or relationships.
The term “separately display” refers to presenting information in distinct regions, groups, or sections on a display screen so that different kinds of information, or information relating to different persons or attributes, can be visually distinguished.

In one embodiment, a server, a terminal, and a user cooperate to implement the invention. The server is implemented by one or more information processing apparatuses including at least one processor, a main memory, a non-volatile storage device, and a network interface. The terminal is implemented by a client-side information processing apparatus such as a portable computing device having a processor, a memory, a visual display device, and a communication interface. The user operates the terminal to provide attribute information and preference information of a person to be met and to utilize product proposal information presented on the visual display device.

The server uses general-purpose hardware, such as an x86-compatible central processing unit, a dynamic random-access memory device, and a solid-state storage device, and software including an operating system, a web server application, an application framework, and a generative AI model interface library. The server can employ, for example, a Linux-based operating system, a web server such as a conventional HTTP server, and an application framework such as a server-side scripting framework or a web application framework. The server uses a generative AI model interface library compatible with a generative AI model provider to transmit prompt sentences and to receive generated text responses.

The terminal uses hardware such as a mobile central processing unit, a graphics processing unit, a touch-sensitive panel, and a wireless communication module. The terminal executes a client application built using a mobile operating system such as a smartphone operating system or a tablet operating system, and uses graphical user interface frameworks provided by the operating system. The terminal includes a visual display device, for example a tablet display panel or a head-mounted display such as smart glasses, that presents the product proposal information to the user.

The server manages data in defined data structures to improve processing efficiency. The server represents attribute information and preference information received from the terminal as structured text data, for example, as a set of key-value pairs internally stored in memory. The server transforms the structured text data into a prompt sentence expressed in natural language. The server concatenates or otherwise combines attribute fields and preference fields into a grammatical expression. For example, when the terminal sends attribute information indicating “music lover” and preference information indicating “baseball fan,” the server constructs a prompt sentence such as:
“The customer is a music lover and a baseball fan. Based on these attributes and preferences, please generate at least 5 concrete product recommendations that can be sold in a physical retail store. For each product, include the product name, product category, and a short reason why it fits the customer.”
   In another example, when the user provides attribute information “enjoys rock music” and preference information “follows professional baseball games” and “often buys small accessories as gifts,” the server constructs a prompt sentence such as:

“The customer enjoys rock music, follows professional baseball games, and often buys small accessories as gifts. Please propose 7 products suitable for sale in a physical retail store, and for each product provide a name, a category, and a one-sentence explanation of why it matches these preferences.”

The server supplies the prompt sentence to a generative AI model. The generative AI model is implemented as a neural network model, such as a transformer-based language model having multiple self-attention layers, feed-forward layers, and embedding layers. The generative AI model includes an input embedding module that converts tokenized prompt sentences into numerical vectors, a stack of attention layers that compute context-sensitive representations by applying scaled dot-product attention, and an output projection layer that maps internal representations to token probability distributions. The generative AI model has been trained prior to deployment using large-scale text corpora by minimizing a loss function, such as a cross-entropy loss between predicted token distributions and ground-truth next tokens. During training, the generative AI model updates weight parameters of attention layers and feed-forward layers by using an optimization algorithm such as stochastic gradient descent or a variant thereof, and may use data augmentation techniques such as random masking, token shuffling constraints, or diversified text sampling to improve generalization. The server configures the generative AI model with parameters, such as a model identifier, a maximum token length, a temperature value for sampling, and a top-k or top-p sampling threshold, to control the variability and length of generated output. The server transmits the prompt sentence and model parameters to the generative AI model via a network interface. The generative AI model computes, for each time step, a probability distribution over vocabulary tokens based on the internal hidden state, and selects output tokens according to the configured sampling method. The model generates product proposal information as a sequence of tokens that form a natural language description of recommended products. The server receives a text-based response from the generative AI model. The server then executes post-processing algorithms on the generated text to convert it into structured data. The server uses a parsing module that identifies list markers, numbering patterns, or line breaks to segment the generated text into multiple proposal items. The server applies regular expression matching, string pattern matching, or a rule-based parser to extract, for each proposal item, at least a name component, a category component, and a reason component. The server stores the extracted components in a structured data representation such as an array of records, where each record includes fields for name information, classification information, and reason information.

The server uses this intermediate structured data to reduce ambiguity and to normalize the generative AI model output. Because the server enforces a fixed schema for product proposal information, subsequent processing on the terminal side can be simplified, and the communication payload between the server and the terminal can be compact and consistent. The server transmits the structured product proposal information to the terminal via a network interface using a machine-readable data format.

The terminal receives the structured data and converts it into internal display models suitable for rendering on the visual display device. The terminal maps each proposal item to a visual element, such as a row in a list-based user interface or an overlay item on smart glasses. The terminal can group proposal items by classification information so that related items are displayed together. The terminal may highlight the relationship between attribute information, preference information, and specific proposal items by, for example, using color-coding or labels indicating which attribute or preference each item addresses. This configuration enables the user to quickly identify how each proposal item corresponds to the provided attributes and preferences.

In one concrete embodiment, the terminal presents a top section showing a summary of attribute information and preference information, for instance, “Attributes: music lover; Preferences: baseball fan,” and a lower section showing a list of proposal items with fields such as “Product name: Team-branded wireless headphones; Category: Audio accessories; Reason: They combine music listening with visible support for the customer's favorite baseball team.” The terminal emphasizes terms such as “music” and “baseball” in the reasons to clarify correspondence. For smart glasses, the terminal renders a reduced subset of the same fields as an overlay in the user's field of view, with quick navigation gestures allowing the user to switch between proposal items while interacting with the person to be met. The server and the terminal jointly improve computer-implemented processing compared to conventional systems by employing specific data structures and algorithms. The server internally maintains attribute information and preference information as structured text data, avoiding repeated parsing of free-form input. The server constructs the prompt sentence through deterministic concatenation and templating, ensuring that the generative AI model receives a consistent format that improves the stability of generated outputs. This structured prompt construction reduces the entropy of the model's input space and leads to more reliable and faster convergence of generation, decreasing processing time for each request.

The server's conversion of model output into a normalized schema yields technical advantages in data management. By transforming unstructured text into structured records with fixed fields, the server reduces memory overhead and complexity of client-side parsing, which enables lighter-weight terminals to efficiently display proposals even over limited network connections. The use of structured data reduces the number of bytes transmitted compared to sending long unstructured text paragraphs, thereby reducing communication load and improving responsiveness in environments with constrained bandwidth.

The generative AI model executes a non-trivial transformation that differs from human manual reasoning or simple rule-based automation. The model applies vector-based attention mechanisms across tokens and computes similarity scores in high-dimensional embedding spaces. The server leverages this capability by encoding context in the prompt sentence so that the model can integrate multiple attributes and preferences simultaneously. While a human might manually compose queries one by one, the model processes the entire prompt sentence at once using parallel matrix operations, which increases throughput and reduces latency. Because the model parameters have been optimized through large-scale training, the resulting product proposals tend to be more coherent and more contextually aligned than simple keyword-based retrieval results, leading to improved accuracy in matching proposals to the attributes and preferences.

The invention also improves the internal processing of the terminal. The terminal does not simply display text; instead, the terminal processes structured product proposal information to manage discrete visual items, each mapped to particular attributes or preferences. The terminal can pre-compute layout structures and cache frequently used visual components, which reduces rendering overhead and improves frame-rate stability on resource-limited devices. The terminal can prefetch and store structured data for multiple persons to be met, and can quickly switch between them without requesting new data from the server, thereby reducing network traffic and improving user experience.

In a further embodiment, the server adjusts prompt sentence content or parameters of the generative AI model according to device characteristics or network conditions. For example, when the terminal reports a narrow display width or limited memory capacity, the server appends additional constraints to the prompt sentence, such as requesting shorter descriptions, or reduces the number of desired proposal items. In another example, when network latency is high, the server reduces the maximum number of generated tokens to shorten generation time. These adjustments are implemented through deterministic logic on the server side and directly modify AI inference complexity, thereby improving computational efficiency and responsiveness.

The generative AI model itself can be configured in multiple variants. In one variant, the generative AI model is a transformer encoder-decoder architecture trained with teacher forcing using an objective function that penalizes deviations from target sequences describing product recommendations. In another variant, the generative AI model is a decoder-only architecture with positional encodings and multi-head self-attention layers. In both variants, the server can log token-level outputs and measure error statistics against known patterns or sample ground truths to dynamically adjust sampling parameters in future requests. This feedback mechanism reduces the probability of generating irrelevant or malformed proposals and enhances the technical reliability of the system.

The training procedure of the generative AI model includes at least: collecting training text data that pairs user attributes and preferences with example product recommendations; tokenizing the text; constructing input-output sequences; computing prediction losses for each token; and updating model weights via backpropagation and gradient-based optimization. The server can further fine-tune the generative AI model on domain-specific data, such as retail-specific proposals, using a learning rate schedule and regularization methods like dropout, to improve domain-specific accuracy. This technical training and fine-tuning process enables the model to produce more consistent structured outputs when driven by the specially constructed prompt sentences, thus improving the quality of downstream structured parsing.

The invention is not limited to product proposals in retail contexts. The server and the terminal can handle different kinds of recommendation domains, such as content suggestions, event proposals, or service bundles, provided that the structured data schema and prompt templates are updated accordingly. In each variant, the core technique remains: the server converts structured attribute information and preference information into an optimized prompt sentence for a generative AI model, transforms the generative AI model output into structured multi-item proposal data, and cooperates with the terminal to provide context-linked visual presentation. This constant structure allows re-use of the same data-processing pipeline to improve processing speed, reduce errors, and provide stable performance across multiple application scenarios.

The server can also implement safety and consistency checks on the generated structured data. For example, the server can verify that each proposal item includes non-empty name information and classification information, or can filter out duplicates based on a similarity function applied to vector embeddings of proposal names. These additional algorithms operate on the structured representation, not on arbitrary raw text, and therefore can be computed rapidly and deterministically, further improving the reliability and predictability of the system.

In summary, the server, the terminal, and the user cooperate in a system in which attribute information and preference information are acquired, transformed into a prompt sentence, used to drive a trained generative AI model, and converted into structured product proposal information that is presented in a technically optimized manner. The system improves computer technology by defining specific internal data structures, using particular neural network mechanisms for generation, applying deterministic parsing and structuring of generated text, and coordinating display logic to reduce computational burden and communication overhead. As a result, the system achieves improved processing speed, accuracy of context-aware proposals, reduced error rates, and more efficient use of both server and terminal resources compared to conventional, less-structured approaches.

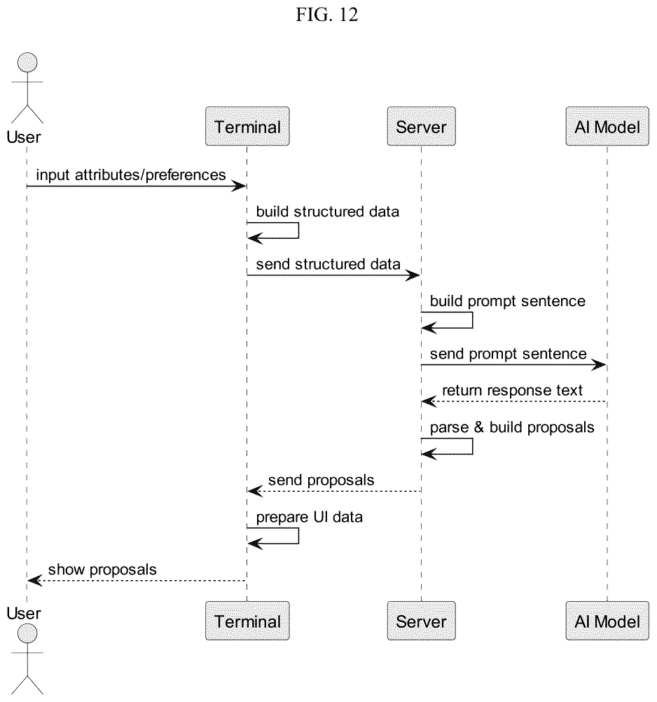

The following describes the processing flow using FIG. 12.

### Step 1:

The terminal displays an input screen for attribute information and preference information.
The terminal uses a graphical user interface to render input fields, labels, and a submission button on a visual display device. The input of this step is an initial screen state without user-provided attribute or preference data. The output of this step is a visible input form that can receive text or selection input from the user.

### Step 2:

The user inputs attribute information and preference information on the terminal.
The user operates a keyboard, a touchscreen, or other input device to enter strings such as “music lover” and “baseball fan” into the input fields provided by the terminal. The input of this step is the user's key presses and touch events. The output of this step is raw text data for attributes and preferences, held temporarily in the terminal's memory as unstructured text.

### Step 3:

The terminal converts the raw text into structured text data and stores it in a storage area.
The terminal takes the unstructured text strings entered by the user and organizes them into a predefined internal data structure, for example an object with distinct fields for attribute information and preference information. The input of this step is the raw text content from the input fields. The terminal performs data formatting, such as trimming whitespace, combining multiple entries into lists, and assigning them to keys in the data structure. The output of this step is structured text data representing attribute information and preference information stored in a memory region of the terminal.

### Step 4:

The terminal transmits the structured text data to the server via a communication interface.
The terminal takes the structured text data and encodes it into a machine-readable transmission format, then creates and sends a communication request to the server over a network. The input of this step is the structured text data stored in the terminal's memory. The terminal performs data serialization and network encapsulation operations to embed the data into a network packet. The output of this step is a transmitted data packet that reaches the server and contains the attribute information and preference information.

### Step 5:

The server receives the structured text data and reconstructs it into an internal representation.
The server listens on a network interface, accepts the incoming request from the terminal, and decodes the received data into an in-memory object. The input of this step is the transmitted data packet carrying structured text data. The server performs network protocol processing and data parsing to reconstruct the attribute information and preference information into an internal representation within main memory. The output of this step is a server-side data object that holds the attribute information and preference information in a structured form.

### Step 6:

The server generates a prompt sentence based on the attribute information and preference information.
The server uses string-processing logic to combine the fields of the internal data object into a coherent natural-language description. The input of this step is the structured data object containing attribute information and preference information. The server executes concatenation, templating, and grammatical arrangement operations to form a single natural-language prompt sentence, such as “The customer is a music lover and a baseball fan. Based on these attributes and preferences, please generate at least 5 concrete product recommendations that can be sold in a physical retail store. For each product, include the product name, product category, and a short reason why it fits the customer.” The output of this step is a text string representing the prompt sentence.

### Step 7:

The server constructs a generation request for the generative AI model using the prompt sentence.
The server wraps the prompt sentence into a request structure that includes the model identifier, control parameters, and the prompt sentence itself. The input of this step is the prompt sentence text and configuration parameters such as maximum token length and sampling temperature. The server performs data aggregation and parameter assignment to form a complete generation request. The output of this step is a generation request object ready to be sent to the generative AI model through a network interface.

### Step 8:

The server transmits the generation request to the generative AI model and initiates inference. The server sends the generation request across a network connection to an endpoint that provides access to the generative AI model. The input of this step is the generation request data structure created in the previous step. The server performs network communication operations by encoding the request into network packets and sending them through a communication protocol to the model provider. The output of this step is a transmitted request that causes the generative AI model to begin processing the prompt sentence.

### Step 9:

The generative AI model generates response text including product proposal information. The generative AI model processes the prompt sentence using internal neural network computations. The input of this step is the prompt sentence and the model parameters received from the server. The generative AI model converts tokens of the prompt sentence into vectors, applies attention mechanisms and feed-forward transformations, and computes probability distributions over output tokens step by step according to its architecture and learned weights. The generative AI model then samples or selects tokens to produce a sequence of output tokens that form product proposal information. The output of this step is a text sequence that describes one or more product proposals in natural language.

### Step 10:

The server receives the response text from the generative AI model.
The server accepts the generated text as part of a response message from the generative AI model endpoint. The input of this step is the network response packet carrying the model's output. The server performs network protocol handling and data extraction operations to retrieve the textual content generated by the model. The output of this step is a raw text string containing the product proposal information stored in the server's memory.

### Step 11:

The server parses the response text and segments it into multiple proposal items.
The server analyzes the raw text string to identify individual product proposals. The input of this step is the unstructured response text. The server executes parsing algorithms such as splitting by line breaks, detecting numbered list patterns, and applying regular expressions to delineate each proposal item. The output of this step is a collection of text segments, each segment corresponding to one proposal item.

### Step 12:

The server extracts name information, classification information, and reason information for each proposal item.
The server interprets each text segment to identify and separate subcomponents. The input of this step is each proposal text segment from the previous step. The server applies pattern recognition rules or string-search operations to locate portions corresponding to a product name, a product category, and a reason. For example, the server may treat the first phrase before a delimiter as name information, a phrase indicating product type as classification information, and a sentence starting with “because” or similar phrasing as reason information. The output of this step is a structured record for each proposal item that includes fields for name information, classification information, and reason information.

### Step 13:

The server constructs structured product proposal information from the extracted records.
The server combines all proposal item records into a unified structured data object, such as an array or list of records. The input of this step is the set of individual proposal item records resulting from the extraction. The server performs aggregation operations to assemble the records into a single data structure that conforms to a predetermined schema for product proposal information. The output of this step is structured product proposal information that encodes all proposal items in a machine-usable form.

### Step 14:

The server transmits the structured product proposal information to the terminal.
The server prepares the structured data for network transmission by serializing it into a transport format and then sending it through a communication channel to the terminal. The input of this step is the structured product proposal information stored in the server's memory. The server performs serialization, packetization, and network dispatch operations to embed this information into a response message directed to the terminal. The output of this step is a transmitted message that carries structured product proposal information to the terminal.

### Step 15:

The terminal receives the structured product proposal information and reconstructs it into internal objects.
The terminal accepts the server's response message and decodes the structured product proposal information back into its internal representation. The input of this step is the received network message containing the structured data. The terminal performs network protocol handling and deserialization processing to produce local data objects representing each proposal item. The output of this step is a set of internal data objects on the terminal that mirror the fields for name information, classification information, and reason information.

### Step 16:

The terminal prepares display data based on the structured product proposal information and the original attribute and preference information.
The terminal combines the structured product proposal information with locally stored attribute and preference information to determine how to present them on the visual display device. The input of this step is the internal data objects representing proposal items and the stored attribute information and preference information. The terminal performs layout planning, grouping operations, and mapping operations that assign proposal items to visual elements and establish visual links or emphasis between specific attributes and corresponding proposal items. The output of this step is a prepared display model that describes what text to show, where to show it, and how to highlight relations.

### Step 17:

The terminal displays the product proposal information on the visual display device in a list or itemized format.
The terminal uses its graphical rendering subsystem to draw user interface components according to the prepared display model. The input of this step is the display model that specifies text content, grouping, and emphasis information. The terminal executes drawing operations to render each proposal item as a visible entry, including its name, classification, and reason, and may apply special formatting to highlight correspondence with attribute and preference information. The output of this step is a visible screen showing the product proposal information in a structured, itemized fashion that the user can read and interact with.

### Step 18:

The user views the displayed product proposal information and utilizes it when interacting with the person to be met.
The user observes the visual display device and interprets the proposal items, relying on the structured format and highlighted correspondences to understand how each item relates to the person's attributes and preferences. The input of this step is the rendered screen produced by the terminal. The user performs cognitive evaluation and may select certain items verbally or through on-screen interactions. The output of this step is the user's informed choice of product proposals that can be conveyed to the person to be met, aided by the structured and context-linked presentation generated by the server and the terminal.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that assist users in communicating with other persons typically rely on static templates, manually curated profiles, or simple rule-based keyword matching. Such systems are limited in their ability to derive a rich, context-sensitive persona of a target person from sparse attribute and hobby information, and therefore tend to generate generic or irrelevant conversation suggestions. Moreover, conventional use of generative AI models in this domain often consists merely of forwarding a user's raw text to a model, without prior machine-based analysis of external information sources or systematic extraction of structured persona data. As a result, the generated content may be inconsistent, may not align with real-world behavioral patterns, and may waste computational resources by invoking complex generative models on unprocessed or noisy input.

From a computer technology perspective, there is a need for an improved processing architecture that (i) transforms unstructured user input into cleaned, semantically meaningful data, (ii) automatically retrieves and analyzes external information to infer statistically grounded persona characteristics, and (iii) integrates such structured persona data with generative AI models through carefully constructed prompt sentences. Absent such an architecture, server-side resources are not efficiently utilized, network bandwidth may be consumed by unnecessary or redundant calls to external services, and the overall responsiveness, reliability, and controllability of conversation-support systems remain inadequate.

Accordingly, an object of the present invention is to provide a computer-implemented system that improves the technical functioning of a server-based conversation support platform by orchestrating natural language preprocessing, external information retrieval, feature extraction, and machine-learned persona estimation prior to interaction with a generative AI model. Another object is to generate prompt sentences that encode both user-provided attributes and machine-inferred persona structures so that the generative AI model produces responses that are more targeted, consistent, and computationally efficient. A further object is to provide the user with conversation points and topic candidates derived from this multi-stage processing, thereby improving the quality and relevance of the output while optimizing processing load and latency on the server.

The specific processing by the specific processing unit 290 of the data processing device 12 in Example 2 is realized by the following means.

The present invention provides a server comprising a processor and a memory storing instructions that, when executed by the processor, cause the processor to acquire, via a user interface, information relating to attributes and hobbies of a person whom a user plans to meet; to perform linguistic processing on the acquired information to execute segmentation processing and removal of unnecessary terms so as to extract search terms; to acquire related information from an external information source via an information retrieval communication interface based on the extracted search terms; to convert the acquired related information into feature data and estimate a persona of the person whom the user plans to meet by using trained discrimination processing or classification processing based on the feature data; to generate a prompt sentence for instructing a generative AI model to generate a response, the prompt sentence being generated based on the acquired information relating to the attributes and hobbies and the estimated persona; to input the generated prompt sentence, and optionally structured data representing the estimated persona, into the generative AI model and acquire, from the generative AI model, a response based on the prompt sentence; and to generate and output presentation information, including conversation points or candidate topics for an initial meeting, based on the estimated persona and the acquired response. This enables the server to technically improve the end-to-end processing pipeline for conversation support by reducing noise in user input, leveraging external information to derive statistically supported persona features, tightly coupling structured persona data with generative AI inference through a controlled prompt sentence, and thereby producing more relevant, consistent, and resource-efficient conversation guidance for the user.
The term “user interface” refers to any hardware or software mechanism through which a user provides input to, or receives output from, the system, including but not limited to graphical user interfaces, touch screens, keyboards, pointing devices, display panels, and audio input/output components.
The term “information relating to attributes and hobbies” refers to descriptive data indicative of characteristics, preferences, or interests of a person, such as favorite genres of entertainment, preferred activities, typical leisure behaviors, or other personal inclination indicators provided in natural language or structured form.
The term “linguistic processing” refers to any automated processing applied to text data that is based on natural language processing techniques, including but not limited to tokenization, segmentation, part-of-speech tagging, stop-word removal, stemming, lemmatization, and syntactic or semantic analysis.
The term “segmentation processing” refers to an operation that divides an input text into smaller units, such as words, tokens, phrases, or sentences, in order to facilitate subsequent analysis or processing.
The term “unnecessary terms” refers to elements of text, such as function words, filler words, or context-irrelevant tokens, that are determined not to materially contribute to the intended analysis or retrieval tasks and that may therefore be removed to improve processing efficiency and accuracy.
The term “search terms” refers to one or more words, tokens, or expressions derived from the input information and selected for use as query elements when retrieving related data from an external information source.
The term “external information source” refers to any data storage or service that is located outside the local execution environment of the server and that can be accessed via a communication network, including but not limited to network-based information services, searchable data repositories, and web-accessible databases.
The term “information retrieval communication interface” refers to a hardware and/or software component configured to transmit queries to, and receive responses from, an external information source over a communication network, using protocols such as HTTP, HTTPS, or other standardized or proprietary communication mechanisms.
The term “related information” refers to data obtained from an external information source that is determined to be relevant to one or more search terms, and that typically includes textual content, metadata, or other descriptors usable for further analysis.
The term “feature data” refers to numerical or symbolic representations derived from raw or preprocessed data, where the representations capture characteristics, patterns, or statistical properties of the data for use in machine learning or other analytical processes.
The term “trained discrimination processing” refers to an operation executed by a trained model that has learned, from example data, to distinguish among categories or classes, such as by assigning input data to one of multiple predefined outputs based on learned parameters.
The term “classification processing” refers to a type of machine learning operation that receives feature data as input and outputs one or more category labels or probability distributions indicating membership of the input in predefined classes.
The term “persona” refers to an abstract representation of a person characterized by inferred traits, interests, behavioral tendencies, or lifestyle patterns, derived from analysis of attribute and hobby information combined with related information from external sources.
The term “prompt sentence” refers to a textual instruction or query formatted for input to a generative AI model, the instruction or query specifying desired output characteristics and optionally including contextual information such as attribute data and persona descriptions.
The term “generative AI model” refers to a computational model, such as a machine-learned language model, that is configured to generate output data, including natural language text, in response to one or more input prompts and optionally structured auxiliary data.
The term “structured data representing the persona” refers to data arranged in a predefined format, such as key-value pairs, lists, or labeled fields, that encodes inferred traits, categories, or other characteristics of a persona in a machine-interpretable manner.
The term “response” refers to output produced by the generative AI model in reaction to a prompt sentence and optional auxiliary data, where the output may include narrative descriptions, suggested topics, explanations, or other natural-language content.
The term “presentation information” refers to information generated by the system for delivery to the user, including but not limited to summaries, lists of conversation points, candidate topics, and explanatory text that assist the user in interacting with another person.
The term “conversation points” refers to suggested items, such as questions, remarks, themes, or angles of discussion, that a user can employ to initiate or sustain communication with another person.
The term “candidate topics” refers to suggested subject matters or themes for conversation, derived from persona information and generated responses, that are proposed as likely to be suitable or engaging in an interaction.
The term “output interface” refers to any hardware or software component that delivers information from the system to the user, including but not limited to display devices, speakers, notification systems, and associated driver software.
The term “statistical feature vector” refers to a multi-dimensional data structure comprising numerical values that encode statistical or quantitative properties of processed information, such as term frequencies, weighted term scores, or other computed measures.
The term “classifier” refers to a machine learning model configured to assign one or more category labels to input feature data, based on parameters obtained through training with labeled example data.
The term “clustering model” refers to a machine learning model configured to group input feature data into clusters or groups based on similarity measures, without requiring explicit labels for each group in the training data.
The term “category information” refers to a representation of one or more classes, labels, tags, or group identifiers that characterize aspects of a person's interests, behavioral tendencies, or lifestyle, as determined by a classifier or clustering model.

In one embodiment, a server cooperates with a terminal operated by a user to implement a conversation-support system based on persona estimation and controlled interaction with a generative AI model. The server includes at least one processor, a memory, a network interface, and non-transitory storage. The terminal includes an input device such as a touch screen or keyboard, a display device such as a liquid crystal display or organic light-emitting diode display, and a communication module such as a wireless communication interface.

The server stores, in the memory or storage, a plurality of software modules. The software modules include a web server module, an application logic module, a natural language processing module, an information retrieval module, a feature extraction module, a machine learning persona estimation module, a generative AI interface module, and a presentation generation module. The server executes these modules on an operating system such as a general-purpose server operating system.

The terminal executes client logic implemented as a web application or native application. The terminal presents, on the display device, a user interface screen that prompts the user to input information relating to attributes and hobbies of a person whom the user plans to meet. The terminal obtains input text from the user through the input device and temporarily stores the input text in a memory area of the terminal. The terminal transmits the input text to the server via the network interface using a communication protocol such as Hypertext Transfer Protocol Secure.

The server receives, through the web server module, the request transmitted from the terminal. The server parses the request to extract the input text. The server stores the input text in an internal data structure, for example, a record comprising a user identifier, a timestamp, and a text field. The server logs metadata such as text length and processing time in a logging storage to support monitoring and performance analysis.

The server uses the natural language processing module to perform linguistic processing on the input text. The server loads a tokenization function and a stop-word dictionary. The server divides the input text into tokens corresponding to words or subwords and removes tokens that match entries in the stop-word dictionary. The server optionally applies part-of-speech tagging to identify nouns, verbs, and adjectives and preferentially retains tokens of those part-of-speech classes. The server optionally applies lemmatization to normalize inflected forms into base forms. The server stores the result as a cleaned token list in an internal data structure, such as an array or list of token strings.

The server uses the information retrieval module to construct a query string from the cleaned token list. The server joins the tokens with separators and performs encoding suitable for a network-based information retrieval interface. The server transmits a request, via the network interface, to an external information source such as a search service. The request includes the query string and authentication parameters. The external information source returns related information as structured data, including document titles, snippets, and resource identifiers. The server extracts textual fields from the returned data and stores them as a document collection in the storage.

The server uses the feature extraction module to convert the document collection into feature data. The server constructs a vocabulary from the document collection and computes term frequency-inverse document frequency values for terms appearing in each document. The server stores the computed values as a statistical feature vector for each document, for example, as a sparse matrix structure in the memory. The server optionally normalizes the feature vectors using a scaling procedure so that each vector has a predetermined norm. The server may further compute derived features such as co-occurrence statistics or n-gram features to capture relationships between tokens.

The server uses the machine learning persona estimation module to infer a persona of the person whom the user plans to meet. In one implementation, the server loads a trained classifier model stored in the non-transitory storage. The classifier model may be implemented as a linear model such as logistic regression, a tree-based model such as a random forest, or a neural network such as a feedforward multilayer perceptron. In one embodiment, the neural network includes an input layer corresponding to the dimension of the feature vectors, one or more hidden layers with nonlinear activation functions, and an output layer producing scores for predefined persona categories. The server supplies the statistical feature vectors to the classifier model and obtains output values such as probability scores for each persona category.

The server converts the output values into category information identifying interests, behavioral tendencies, or lifestyle patterns. The server stores the category information in a persona data structure that includes one or more category labels, associated confidence scores, and optional free-text descriptors. In a variant embodiment, the server applies a clustering model such as a k-means model or a Gaussian mixture model to group feature vectors into clusters that represent distinct persona types. The server then assigns a cluster index to the person and maps the cluster index to a set of persona descriptors in a lookup table.

The server uses the generative AI interface module to construct a prompt sentence for a generative AI model. The server combines the original input text and the inferred persona data. The server arranges these elements according to a regularized prompt template stored in memory. For example, the server may generate a prompt sentence such as:
“The user has provided the following profile: ‘He likes jazz music and often goes to live shows on weekends.’ From data analysis, it is estimated that this person frequently attends jazz festivals, visits small jazz clubs, and collects classic jazz albums. Based on this, generate a detailed persona description and 5 specific conversation topics that would be suitable for a first meeting.”

In another example, the server may generate a prompt sentence such as:
“A user has provided this description of another person: ‘She likes rock music, visits art museums on weekends, and follows indie bands.’ Using this information, infer a realistic persona and generate 10 specific, natural conversation starters and follow-up questions that will help to build rapport.”

In yet another example, the server may generate a prompt sentence such as:
“The profile is: ‘Enjoys classical music concerts, reads historical novels, and travels to European cities once a year.’ Please estimate personality traits, typical hobbies, and preferred discussion themes, and then propose 5 example conversation topics and 5 questions that another person can use in a first-time conversation.”

The server prepares, as structured data, a representation of the persona including category labels, confidence scores, and key terms, and associates this data with the prompt sentence. The server transmits the prompt sentence and, optionally, the structured persona data, to the generative AI model through a generative AI model interface. The generative AI model may be deployed as a remote service accessible via an application programming interface.

In one embodiment, the generative AI model is implemented as a transformer-based neural network trained on large corpora of text. The neural network architecture includes multiple attention layers, feedforward layers, and normalization layers. The model parameters include weight matrices for attention heads and feedforward projections. During inference, the model receives a sequence of tokens corresponding to the prompt sentence and optional special tokens that encode persona categories. The model computes, by repeated application of attention and feedforward operations, a probability distribution over vocabulary tokens for the next position and generates a sequence of output tokens that constitutes the response.

The server receives the response from the generative AI model as a sequence of tokens or as a text string. The server stores the response in the memory and may optionally segment the response into sections such as a persona narrative and a list of conversation topics. The server uses the presentation generation module to construct presentation information that combines the inferred persona data and the generated response. The server may, for example, generate a summarized persona profile, bullet lists of conversation points, and an explanation of why certain topics are likely to be effective.

The terminal receives the presentation information from the server via the communication module. The terminal parses the received data and renders the persona profile and conversation topics on the display device. The terminal may arrange the information with a title region for the overall persona, a body region for detailed traits, and a list region for suggested questions. The user reads the displayed information and uses the suggested conversation points in an actual interaction with the person whom the user plans to meet.

In this configuration, the server exploits the combination of preprocessing, external information retrieval, feature-based persona estimation, and controlled generative AI interaction to improve computer-implemented processing. The server reduces noise in the input by linguistic processing prior to any external retrieval, thereby improving precision of search results and reducing redundant network traffic. The server structures the retrieved data into feature vectors and applies trained models to infer persona categories, thereby constraining the space of possible outputs from the generative AI model. By encoding both user-provided attributes and machine-inferred persona data into a prompt sentence, the server reduces the number of iterations required to obtain a relevant response, lowering latency and computational cost.

The server improves technical performance in several respects. First, the feature extraction and classification pipeline limits the size and scope of the prompt sentence to only essential attributes and persona descriptors, leading to reduced token counts and shorter inference times in the generative AI model. Second, the persona estimation module filters and aggregates external data into compact statistical representations, which allows the server to cache and reuse learned persona structures for similar input cases, reducing repeated retrieval. Third, the combination of structured persona data and adaptive prompt templates improves the determinism and consistency of responses, facilitating downstream processing such as caching, indexing, or incremental updates.

The server trains the classifier or clustering model using a corpus of annotated examples stored in the storage. During training, the server computes a loss function such as cross-entropy loss between predicted category distributions and ground truth labels. The server applies a weight update algorithm such as stochastic gradient descent or an adaptive optimization method to adjust model parameters. The server may augment training data by applying text augmentation techniques such as synonym replacement, random insertion, or paraphrasing, thereby improving model robustness. The server stores the trained weights in persistent storage and loads them into memory when executing persona estimation.

The server also cooperates with the terminal to manage communication resources. The server may determine that, for certain low-confidence cases in persona estimation, additional retrieval is required and may selectively request more detailed external information. Conversely, if the persona estimation module indicates high confidence based on previously cached results, the server may skip retrieval and generative AI invocation and instead serve a previously generated persona explanation, thereby reducing network and compute load.

In an alternative embodiment, the server executes the generative AI model locally instead of invoking a remote service. In this case, the server stores model parameters in a local storage device and performs inference by executing the attention and feedforward operations on a hardware accelerator such as a graphics processing unit. The server thereby reduces dependency on external model endpoints and can tune inference parameters such as beam width, temperature, and maximum token length more directly to optimize technical metrics such as throughput and response latency.

In another embodiment, the terminal performs a subset of the preprocessing operations. For example, the terminal may tokenize user input and perform basic stop-word removal before transmitting data to the server. This arrangement reduces the volume of data transmitted and distributes computational workload between the terminal and the server. The server then focuses on feature extraction, persona estimation, and generative AI-based response generation.

Because the server introduces structured, multi-stage technical processing—linguistic normalization, feature-based external data integration, machine-learned persona inference, and controlled prompt construction for a generative AI model—the system does not merely automate a human mental process. Instead, the system improves the operation of the computing environment itself by reducing unnecessary model invocations, lowering bandwidth consumption, and increasing output relevance. The causal relationship between these processing steps and the technical effects can be observed as reductions in average response time, improvements in persona classification accuracy, and decreased variability of generative model outputs for similar inputs.

The described embodiments are illustrative, and the server, terminal, and user may interact in various configurations. The server may employ different types of feature extraction algorithms, classification models, or generative AI architectures, provided that the server continues to implement the technical combination of preprocessing, external information retrieval, feature-based persona estimation, and prompt-based generative response generation. The terminal may be any type of communication device capable of input and output, and the user may be any operator who wishes to obtain improved conversation support based on the system's technical processing.

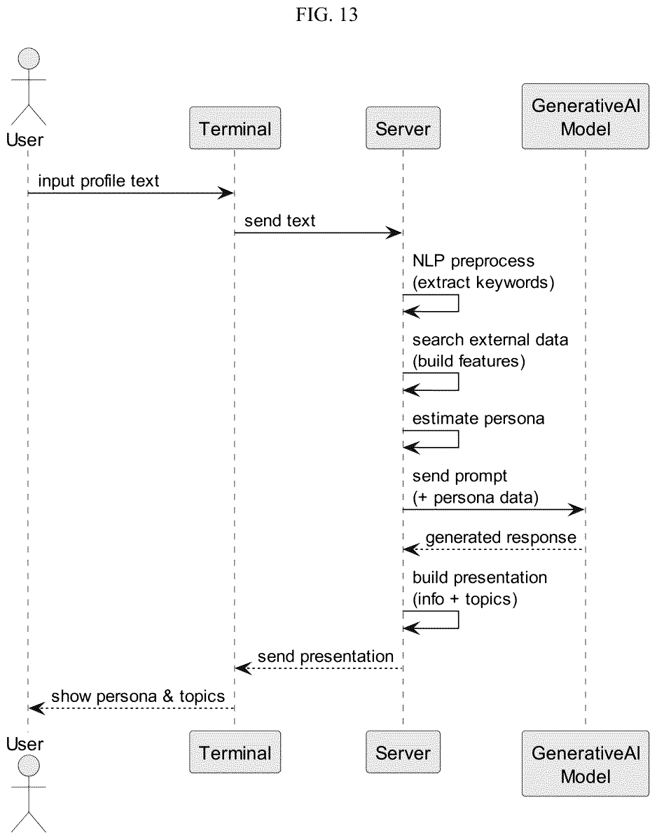

The following describes the processing flow using FIG. 13.

### Step 1:

The user operates the terminal to input information relating to attributes and hobbies of a person whom the user plans to meet.
The terminal displays an input screen and receives a text string such as “He likes jazz music and often goes to live shows on weekends.” via a touch screen or keyboard.
Input: raw natural-language text entered by the user.
Output: a request payload containing the raw text and optional metadata (user ID, timestamp), stored temporarily in the terminal memory.

### Step 2:

The terminal transmits the request payload to the server via a network.
The terminal constructs an HTTP or HTTPS request including the raw text in a structured format, and sends it using a communication module such as a wireless network interface.
Input: the request payload with the raw text and metadata.
Output: a network message delivered to the server containing the input text and metadata.

### Step 3:

The server receives the network message and parses the payload.
The server extracts the raw text field, records log entries (such as length of text and reception time), and stores the text in an internal data record.
Input: the network message from the terminal.
Output: stored raw text and associated metadata in a server-side data structure.

### Step 4:

The server performs linguistic preprocessing on the raw text.
The server uses a natural language processing library to tokenize the text into word units, remove stop-words such as articles and conjunctions, optionally apply part-of-speech tagging to filter for content words, and apply lemmatization to normalize word forms.
Input: raw text string from the data record.
Output: a cleaned token list or normalized text sequence representing only meaningful content terms.

### Step 5:

The server extracts search terms from the cleaned tokens and constructs a query string.
The server selects tokens that satisfy conditions such as being nouns, verbs, or adjectives and concatenates them into a query expression, then performs encoding suitable for an external search interface.
Input: cleaned token list or normalized text.
Output: a formatted query string intended for use with an external information source.

### Step 6:

The server queries an external information source using the constructed query string.
The server sends a search request via an information retrieval communication interface and receives search results that include document titles, snippets, and resource identifiers.
Input: the formatted query string.
Output: a collection of related information, represented as a set of documents with textual fields.

### Step 7:

The server converts the collected related information into feature data.
The server builds a vocabulary from the document collection, computes term frequency-inverse document frequency values or other statistical measures for each document, and stores the results as numerical vectors in a structured matrix.
Input: the document collection with text snippets and titles.
Output: a statistical feature vector for each document and a feature matrix suitable for machine learning.

### Step 8:

The server estimates a persona based on the feature data.
The server inputs the feature matrix into a trained classifier or clustering model, obtains category scores or cluster identifiers, and maps those outputs to persona descriptors such as likely interests, behavioral tendencies, or lifestyle categories.
Input: the feature matrix derived from the related information.
Output: a persona data structure containing category labels, confidence scores, and associated descriptors.

### Step 9:

The server generates a prompt sentence for a generative AI model by combining the original user input and the estimated persona.
The server inserts the user's attribute and hobby text and the persona descriptors into a predefined template to create a natural-language instruction that clearly requests a persona explanation and conversation topics.
Input: the raw text from the user and the persona data structure.
Output: a prompt sentence that encodes both the user's description and machine-inferred persona traits.

### Step 10:

The server sends the prompt sentence, and optionally structured persona data, to the generative AI model and obtains a response.
The server transmits the prompt through a generative AI interface, receives a generated text sequence, and converts the token sequence into a readable text string.
Input: the prompt sentence and optional structured persona data.
Output: a generated response including a persona narrative, conversation points, and suggested topics.

### Step 11:

The server generates presentation information for the user based on the estimated persona and the generated response.
The server analyzes the response text to segment persona description and conversation suggestions, merges them with the structured persona data, and formats them into a structured output suitable for display, such as a summary section and bullet lists.
Input: the persona data structure and the generated response text.
Output: presentation information comprising a persona summary, detailed traits, and one or more lists of conversation points and candidate topics.

### Step 12:

The server sends the presentation information to the terminal.
The server encapsulates the presentation information in a response message and transmits it via the network interface back to the terminal using a communication protocol such as HTTPS.
Input: the presentation information generated by the server.
Output: a network response delivered to the terminal containing the persona summary and conversation suggestions.

### Step 13:

The terminal receives the response and renders the presentation information on the display.
The terminal parses the received data, constructs a user interface layout with headings and bullet points, and outputs the content on the display device; optionally, the terminal may also generate audio output through a speaker.
Input: the network response with presentation information.
Output: visual and/or auditory output presented to the user, including persona details and conversation topics.

### Step 14:

The user reviews the presented information and, optionally, refines the input for further processing.
The user reads the persona summary and conversation suggestions, applies selected topics in real-world conversation, and may input additional or corrected attributes and hobbies through the terminal for subsequent iterations of the processing flow.
Input: displayed persona information and the user's updated understanding of the person.
Output: new or refined text input provided by the user, which can be sent again to the server to repeat the above steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented dialog support systems and recommendation systems rely primarily on static profiles or single-source inputs, such as a user's declared interests or a single interaction channel (for example, text). In such systems, prompt sentences for a generative AI model are typically constructed in a fixed or rule-based manner from the declared attributes alone, without considering dynamic multimodal signals, such as real-time voice characteristics, facial expressions, or measured conversation activity. As a result, these systems often generate generic responses, fail to adapt to changes in user state during a conversation, and cannot reliably support users in maintaining a natural, engaging dialog with another person, particularly in first-meeting situations.

From a computer-technology perspective, existing architectures also treat emotion recognition, information retrieval, and generative AI as loosely connected or independent modules, with minimal feedback loops between recognition outputs and prompt construction. This leads to inefficient use of computational resources and model capabilities, because prompt sentences are not systematically optimized based on multimodal analysis, and the generative AI model is not driven by structured, context-rich control signals that reflect real-time conversation metrics. Moreover, current systems do not provide a unified mechanism by which a processor fuses multimodal emotion estimates, evaluates conversation activity as a computable metric, and then automatically rewrites prompt sentences and downstream response content in a closed feedback loop.

Accordingly, there is a need for an improved computer-implemented system that (i) acquires and integrates attribute and preference information regarding a person to be met, (ii) estimates a person profile using large-scale information retrieval, (iii) recognizes emotional states from both voice information and image information, (iv) evaluates a conversation activity level from fused multimodal emotion data, and (v) dynamically adjusts prompt sentences and generated responses for a generative AI model based on these evaluations. By addressing these technical issues, the system can improve the quality, relevance, and adaptability of generated dialog and recommendation outputs, thereby enhancing the technical functioning of dialog-support and recommendation platforms implemented on computing hardware.

The specific processing by the specific processing unit 290 of the data processing device 12 in Application Example 2 is realized by the following means.

The present invention provides a server comprising a processor configured to acquire, via a user interface, attribute information or preference information regarding a person to be met and optionally past history information; obtain, based on the attribute information or the preference information and the past history information, related information from an information retrieval processing apparatus and estimate a person profile corresponding to the person to be met; generate, based on the person profile and the attribute information or the preference information, a prompt sentence that instructs a generative AI model to generate response content or dialog content; input the prompt sentence to the generative AI model and obtain, from the generative AI model, response information or dialog information; analyze voice information acquired from a user or a customer by using a voice recognition processing apparatus and estimate an emotional state based on the analyzed voice information; analyze image information acquired from the user or the customer by using an image recognition processing apparatus and estimate an emotional state based on a facial expression included in the analyzed image information; integrate the emotional state based on the voice information and the emotional state based on the image information, evaluate a conversation activity level based on a result of the integration, and dynamically adjust content of the prompt sentence or the response information in accordance with an evaluation result of the conversation activity level; and generate topic information, advertisement information, or recommendation information based on the response information or the dialog information and present the topic information, the advertisement information, or the recommendation information to the user or the customer. This enables a closed-loop, computer-implemented dialog support and recommendation process in which multimodal emotion recognition and conversation activity evaluation are fed back into prompt sentence generation for the generative AI model, thereby improving the technical quality, context sensitivity, and adaptability of generated dialog and recommendation outputs executed by the server.
The term “processor” refers to a hardware-based or virtual computing element, such as a central processing unit or processing core, that executes instructions to perform logical, arithmetic, control, and input/output operations required to implement the functions of the system.
The term “user interface” refers to any combination of hardware and software components that enable a user to input information to, and receive information from, the system, including, for example, graphical user interfaces, voice-based interfaces, and touch-based interfaces.
The term “attribute information” refers to information indicating characteristics of a person, such as demographic characteristics, behavioral characteristics, or situational characteristics, including, for example, age group, occupation category, or communication style.
The term “preference information” refers to information indicating likes, dislikes, interests, or tastes of a person, including, for example, favored content categories, typical activities, or thematic interests.
The term “past history information” refers to information indicating previous interactions, behaviors, or records associated with a user or a customer, such as prior conversations, search histories, or content access logs.
The term “information retrieval processing apparatus” refers to a hardware and software system configured to store large-scale data and to search, retrieve, and provide related information in response to queries based on attribute information, preference information, or other parameters.
The term “person profile” refers to structured or semi-structured data representing an estimated or inferred characterization of a person, including one or more predicted attributes, preferences, or behavioral tendencies derived from input information and retrieved information.
The term “prompt sentence” refers to a machine-readable natural language instruction or control string provided as input to a generative AI model, the instruction or control string specifying conditions, constraints, or desired characteristics of output content to be generated by the generative AI model.
The term “generative AI model” refers to an information processing model implemented in software and executed on computing hardware, the model being configured to generate new content, such as natural language text, based on received input data including a prompt sentence.
The term “response content” refers to generated informational content, including textual data, that is produced by the generative AI model in response to a prompt sentence and is suitable for use as an answer, suggestion, or guidance.
The term “dialog content” refers to generated content representing one or more utterances or dialog turns intended to simulate or support an interactive conversation between a user and another party.
The term “response information” refers to data obtained from the generative AI model based on a prompt sentence, including, but not limited to, response content, dialog content, and associated metadata indicating structure or context of the generated data.
The term “dialog information” refers to information that describes or constitutes a sequence of dialog turns, including generated utterances, speaker roles, and optional timing or structural annotations.
The term “voice information” refers to audio data representing spoken sounds or speech emitted by a user or a customer, including raw or processed audio signals suitable for speech recognition and acoustic analysis.
The term “voice recognition processing apparatus” refers to a hardware and software system configured to receive voice information and perform operations such as speech-to-text conversion, acoustic feature extraction, or related processing.
The term “image information” refers to visual data, such as still images or video frames, representing a scene that includes at least a portion of a face or upper body of a user or a customer.
The term “image recognition processing apparatus” refers to a hardware and software system configured to analyze image information, detect regions of interest such as faces, and extract features for tasks including expression recognition.
The term “emotional state” refers to an estimated psychological or affective condition of a person, represented by one or more discrete categories or continuous values, such as happiness, neutrality, nervousness, or engagement.
The term “conversation activity level” refers to a quantitative or qualitative metric indicating an activity degree or liveliness of a conversation, determined based on factors including response timing, utterance length, and emotional state.
The term “topic information” refers to data describing one or more subject matters or themes suitable as candidates for conversation, such as questions, talking points, or headings.
The term “advertisement information” refers to data describing commercial or promotional content relevant to a user or a customer, including textual messages, offers, or pointers to products or services.
The term “recommendation information” refers to data indicating suggested items, actions, or content for a user or a customer, such as suggested conversation topics, content items, or product categories.
The term “simulated dialog” refers to an artificial or virtual conversation generated or controlled by the system, in which dialog information is produced to mimic a possible real-world interaction.
The term “actual dialog support” refers to assistance provided by the system during a real conversation between a user and another person, including provision of dialog information or topic information in real time or near real time.
The term “natural language processing technique” refers to a computational method or algorithm that processes, analyzes, or generates human language text, including tasks such as tokenization, parsing, semantic analysis, and topic extraction.
The term “feedback information” refers to information presented to a user that summarizes or evaluates conversation behavior, emotional state, or interaction outcomes, and that optionally includes suggestions for improvement.
The term “dialog improvement instruction information” refers to guidance data generated for a user, instructing or advising the user on how to modify or enhance dialog behavior, such as changing question types, adjusting topic choices, or altering interaction style.

In one embodiment, a server implements the claimed system by executing a program stored in a storage device and running on one or more processors. The server is connected, via a communication network, to at least one terminal operated by a user. The terminal may be realized as a smartphone, a tablet, a wearable display device such as smart glasses, or a head-mounted display, and includes at least a display, an audio input device such as a microphone, and an image capturing device such as a camera.

The server uses a general-purpose operating system, such as a server operating system, and executes application software implemented, for example, in a programming language running on a web framework. The server may use a relational database management system to store user-related data, attribute information, preference information, person profiles, conversation logs, and model parameters. The server may further use a search platform, such as a full-text search engine, and external or internal information retrieval processing apparatuses accessible via network APIs.

The terminal executes a client application. The terminal presents, by way of a user interface, input screens that enable the user to provide attribute information and preference information regarding a person to be met. Such screens include text input fields, selection lists, toggles, and voice input controls. The terminal converts the user's input into structured data, for example into key-value pairs, and transmits this data to the server using an application-layer protocol over a secure channel.

The server receives the attribute information and preference information and stores them in structured records. The server associates the received information with identifiers for the user and the person to be met. The server normalizes textual content of the attribute information and preference information by applying a natural language processing pipeline. In one configuration, the server uses a natural language processing library to perform tokenization, lowercasing, stop-word removal, and lemmatization. The server stores the normalized tokens and derived tags in dedicated database tables. This pre-processing reduces dimensionality and noise in the subsequent machine learning computation, thereby improving computational efficiency and accuracy of person profile estimation.

The server uses the normalized attribute information and preference information to construct queries to an information retrieval processing apparatus. The information retrieval processing apparatus can be implemented as a search engine that indexes large-scale data, such as public documents, content catalogs, or internal log data. The server embeds keywords such as musical genres, artist names, age ranges, or interest categories into query structures and transmits the queries using a network protocol. The server receives responses that include ranked documents, structured records, or statistical aggregates. The server transforms the responses into internal data structures, such as arrays of items, where each item contains fields including title, description, category, temporal metadata, and geospatial metadata. The server estimates a person profile by combining the attribute information, preference information, and the retrieved information. In one implementation, the server constructs feature vectors that encode categorical attributes by one-hot encoding, continuous attributes by normalization, and text-derived attributes by term-frequency or embedding vectors. The server feeds the feature vectors to a machine learning model. The model may be a discriminative classifier, such as a gradient-boosted decision tree, or a neural network implemented with a numerical computation framework. In the neural network embodiment, the model may adopt a feed-forward architecture with multiple fully connected layers, where each layer applies linear transformation followed by a non-linear activation function such as rectified linear units. The model outputs one or more profile labels, such as interest segments, behavior tendencies, or conversation style attributes, together with confidence scores. The server stores the estimated person profile, including the labels and scores, as structured profile data.

The server generates a prompt sentence based on the person profile and the original attribute information and preference information. The server uses template structures and rule-based composition logic, not merely concatenation of attributes, to construct a semantically controlled natural language instruction. For example, the server may select different templates depending on whether the estimated person profile includes a label corresponding to “introverted” or “extroverted” and depending on the main preference category. The server may generate a prompt sentence such as:
“Act as a polite, slightly shy person in their thirties who loves the Beatles and classic rock and frequently attends live concerts. Simulate a first-time conversation with the user. Start by asking about the user's favorite Beatles album and then ask three follow-up questions in simple, friendly sentences.”

The server then transmits this prompt sentence to a generative AI model. The generative AI model is implemented as a trained neural language model hosted on the server or on a separate computation node. The model may adopt a transformer architecture having multiple self-attention layers, multi-head attention mechanisms, and feed-forward layers. The model has been pre-trained on large corpora using masked language modeling or next-token prediction objectives and optionally fine-tuned on dialog datasets. The server controls operational parameters of the generative AI model, such as sampling temperature, top-k sampling, or maximum output length, via model configuration data. By adjusting these parameters according to the conversation context, the server can influence diversity and determinism of the generated dialog content.

The server receives output tokens from the generative AI model and constructs response information or dialog information as text strings. The server optionally segments the output into conversational turns by detecting token patterns such as “User:” or “Partner:” or by using learned delimiters, and stores each turn with speaker role labels and time stamps. This structuring enables subsequent analysis and efficient retrieval of conversation segments, improving data management and supporting incremental update of conversation scenarios. The terminal receives the dialog information and displays it to the user. The terminal may display the dialog content in a chat-style user interface or overlay short suggestions on a wearable display. Alternatively or additionally, the terminal may synthesize audio rendering of the partner's utterances via a text-to-speech engine and output them through speakers or earphones. The user can then respond verbally or via text. When the user responds verbally, the terminal captures voice signals with its microphone and transfers audio data to the server. The server processes voice information using a voice recognition processing apparatus. The voice recognition processing apparatus may include a speech-to-text engine that uses an acoustic model and a language model to convert audio waveforms into sequences of text tokens along with timing information. The server stores the recognized text and timing, and further extracts acoustic features such as average energy, pitch contour, speech rate, and pause duration using a signal processing library. The server passes these features to an emotion estimation model implemented, for example, as a recurrent neural network or a temporal convolution network. The emotion estimation model may be trained using supervised learning with labeled emotional states and a loss function such as cross-entropy. During training, the model's weights are updated by a stochastic gradient descent algorithm or a variant such as Adam, based on the gradient of the loss with respect to the model parameters. The trained model outputs an emotional state classification for each time segment. The server associates the emotional state with segments of the dialog information. The terminal also captures image information using its camera. The terminal periodically transmits frames to the server. The server uses an image recognition processing apparatus to detect faces and infer facial expressions. In one embodiment, the server applies a face detection algorithm based on a convolutional neural network to locate face regions in the image. The server then feeds cropped face images into a facial expression classifier, which may be another neural network trained on facial expression datasets. The classifier outputs emotion scores such as happiness, sadness, surprise, or neutrality. The server aligns these emotion scores with the timing of the voice-based emotional states.

The server integrates the emotional states derived from voice information and image information. In one example, the server builds a feature vector that concatenates voice-based emotion probabilities, face-based emotion probabilities, and conversation context features such as dialog segment index and utterance length. The server inputs the feature vector into a small feed-forward network or a logistic regression model that outputs a fused emotional state and a conversation activity level. The conversation activity level can be computed as a continuous variable, for example between 0 and 1, based on response speed, variety of vocabulary, and positivity of emotions. This fusion and evaluation process uses weighted combinations and learned parameters, rather than static rules, thereby enabling improved robustness and precision over single-source heuristics.

By maintaining the fused emotional state and conversation activity level as time-series data, the server can perform efficient dynamic control of prompt sentences. The server periodically evaluates whether the conversation activity level falls below or exceeds certain thresholds. When an activity level is low, the server generates a modified prompt sentence that instructs the generative AI model to simplify questions, introduce lighter topics, or include supportive phrases. For example, the server may generate:
“The user seems quiet and slightly nervous. Generate two very simple, encouraging questions about the Beatles, avoid deep technical details, and add one short compliment about their music taste.”

When the activity level is high, the server may generate a different prompt sentence such as:
“The user is highly engaged and happy. Generate three deeper follow-up questions about live concerts and rare Beatles recordings, using more detailed vocabulary.”

Because the server adjusts the prompt sentences using quantitative measures derived from multimodal inputs and learned models, the generative AI model is effectively controlled as a reconfigurable component within a closed-loop system. This control improves the relevance and personalization of the generated dialog at each time step while also reducing unnecessary recomputation by reusing context and applying smaller, targeted prompt updates. This contributes to improved computational efficiency and reduced communication load between the server and the generative AI model execution environment.

The server uses the response information and dialog information not only to simulate conversations but also to generate topic information, advertisement information, and recommendation information. For example, when the person profile and preference information indicate interest in music, and the fused emotional state indicates a happy and engaged mood, the server retrieves candidate items such as events, products, or content from a catalog database using structured queries. The server then constructs a prompt sentence that includes these items as input for the generative AI model, such as:
“Based on the following profile: a person who loves the Beatles, classic rock, and live concerts, and is currently happy and relaxed, create three short advertisement messages under 30 words each, highlighting upcoming music events and new albums from related artists.”

The generative AI model outputs advertisement information tailored to the profile and emotional state. The server filters and ranks this advertisement information by applying additional criteria, such as relevance scores computed from similarity between item features and profile features. The terminal displays the ranked advertisement information to the user in a form suited to the device, such as list items on a smartphone or compact overlay cards on smart glasses.

In another usage scenario, the server generates topic information for real-time support during an actual dialog between the user and a customer. The server analyzes customer voice and facial expressions similar to the user's. The server then computes a conversation activity level and emotional state for the customer. If the customer shows interest in a particular category, such as sports or music, the server constructs a prompt sentence such as:
“The customer currently shows strong interest in music and appears happy and engaged. Suggest three short, friendly conversation topics related to music that the user can use right now. Output only bullet-point topics.”

The generative AI model returns topic information that the server forwards to the terminal.

The terminal displays this topic information in real time so that the user can easily select the most appropriate topic while maintaining visual contact with the customer. This real-time assistance ties the computational processing to the concrete control and use of hardware devices, improving the effectiveness of human-machine interaction in physical environments.

The system improves computer technology in several respects. Because the server adaptively constructs prompt sentences based on quantitative conversation activity and fused multimodal emotion, the generative AI model is guided with more precise and context-rich conditioning than in conventional static systems. This leads to higher accuracy and consistency in generated responses, which in turn reduces the need for repeated correction or manual intervention, thus decreasing overall processing time and server-client communication frequency. The multimodal fusion mechanism enhances robustness of emotion estimation compared with single-modality approaches, thereby reducing misclassification errors that would otherwise cause inappropriate dialog generation. The modular design of the server—separating pre-processing, information retrieval, profile estimation, prompt generation, generative modeling, and post-processing—enables optimized data structures and memory layouts for each module. For instance, tokenized text and features are stored in compact vector formats, which allows efficient batch processing on processors and accelerators. The training of the neural models used in the system further contributes to technical improvements. The emotion estimation models are trained on curated corpora where each segment is labeled with emotional states and conversation context. During training, the server applies data augmentation techniques, such as time-stretching or pitch-shifting for audio and random cropping or lighting adjustment for images, to improve generalization. The server defines loss functions that combine classification error and temporal smoothness constraints to stabilize predictions over time. The generative AI model may be fine-tuned using supervised learning on dialog datasets annotated with conversation success metrics. By incorporating conversation activity signals into fine-tuning, the model learns to produce outputs that are more likely to sustain high activity levels. These learning procedures and model structures go beyond mere business-rule automation and represent technical solutions that adjust algorithmic behavior of the system.

The system can be implemented in alternative configurations. In one variation, the server executes all heavy computation, while the terminal focuses on capturing and presenting data. In another variation, the terminal includes an on-device light-weight model for preliminary emotion estimation, thereby reducing bandwidth usage and enabling lower-latency feedback; in this case, the server receives preliminary emotion labels and refines them using more complex models. In yet another variation, the person profile estimation uses a clustering-based approach where a clustering algorithm groups profiles, and the server assigns new profiles to clusters for which specialized prompt templates and generative configurations exist, thus improving generation speed by selecting cluster-specific parameters.

The server may further implement caching mechanisms for prompt sentences and partial responses. When similar person profiles are detected, the server can reuse previously generated prompt structures and only update portions related to current emotional state or activity level. This approach reduces computation in the generative AI model and shortens response time perceived by the user. The server may compress conversation logs and profile data using encoding schemes suited to the expected distribution of feature values, which reduces storage size and improves retrieval speed.

Overall, the described embodiments enable a system in which the server, the terminal, and the user cooperate to realize context-aware, multimodal, and dynamically controlled dialog support and recommendation functions. The server's concrete use of specific hardware and software modules, defined data structures, neural network architectures, and control algorithms ensures that the invention is practiced as a technical solution that improves the functioning of computer-based dialog and recommendation systems, rather than merely automating human mental processes.

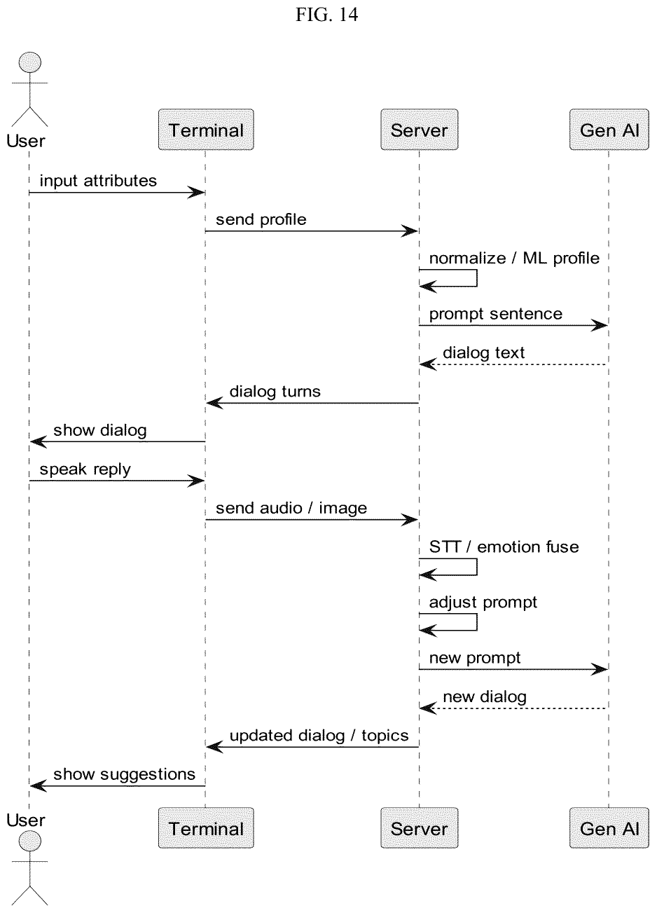

The following describes the processing flow using FIG. 14.

### Step 1:

The user operates the terminal to input attribute information and preference information.
The terminal displays input fields such as text boxes and selection lists on a screen and receives user operations via a touch panel or keyboard.
Input: free-form text such as “male in his thirties, likes the Beatles, loves live concerts” and selected items such as “hobby: music.”
Processing: the terminal packages these values into a structured data object with keys for age group, gender category, and preference category.
Output: a structured attribute/preference record that is ready to be transmitted to the server.

### Step 2:

The terminal transmits the attribute/preference record to the server.
The terminal encodes the data as a message, attaches a user identifier, and sends the message over a network connection using a request protocol.
Input: the structured attribute/preference record generated in Step 1.
Processing: the terminal serializes the record into a transmissible format, adds headers such as authentication tokens, and opens a secure channel to the server.
Output: a network request containing the attribute/preference record that arrives at the server.

### Step 3:

The server receives and validates the attribute/preference record.
The server parses the request body, checks the presence and format of required fields, and rejects or logs malformed records.
Input: the serialized attribute/preference record from the terminal.
Processing: the server converts the serialized data into an internal object, verifies that each field conforms to predefined patterns, and normalizes categories such as age and hobby into internal codes.
Output: a validated and normalized profile object that is stored in a data store and passed to subsequent modules.

### Step 4:

The server performs text normalization and keyword extraction on the profile object.
The server applies a natural language processing pipeline to free-form descriptions within the attribute information and preference information.
Input: textual fields such as “likes the Beatles and classic rock, often goes to live concerts.”
Processing: the server tokenizes the text, converts tokens to lower case, removes stop-words, and applies lemmatization, then computes term frequencies and identifies domain-specific keywords such as “Beatles,” “classic rock,” and “concerts.”
Output: a set of normalized tokens and a keyword list attached to the profile object.

### Step 5:

The server queries an information retrieval processing apparatus to obtain related information.
The server constructs search queries using the keyword list, normalized categories, and optional past history information.
Input: the profile object including normalized attributes and keyword list, and optionally log-derived history such as recent searches.
Processing: the server formats queries, sends them to the information retrieval apparatus, and receives results such as documents or records with associated scores.
Output: a collection of retrieved items containing titles, summaries, categories, and scores that are associated with the profile object.

### Step 6:

The server estimates a person profile using machine learning based on the profile object and the retrieved items.
The server converts categorical fields and keyword frequencies into feature vectors and feeds them into a trained model.
Input: structured attributes (age group, hobby category), keyword frequencies, and retrieval scores for content types.
Processing: the server encodes each input feature into numerical form, concatenates them into a vector, and passes the vector through a machine learning model such as a multi-layer neural network; the model multiplies the vector by weight matrices, applies activation functions, and computes probabilities for profile labels.
Output: an estimated person profile including one or more labels such as “strong music fan,” “Beatles-focused,” and “frequent live attendee,” along with confidence values.

### Step 7:

The server constructs a prompt sentence for a generative AI model based on the estimated person profile and the original attributes and preferences.
The server selects a template and fills slots using profile labels and attributes.
Input: the estimated person profile with labels and the normalized attribute/preference information.
Processing: the server chooses a template according to labels such as “shy” or “talkative,” inserts profile details into template slots, and adds instructions about question type and language style.
Output: a complete prompt sentence, for example, “Act as a polite, slightly shy person in their thirties who loves the Beatles and classic rock and frequently attends live concerts. Simulate a first-time conversation with the user. Start by asking about the user's favorite Beatles album and then ask three follow-up questions in simple, friendly sentences.”

### Step 8:

The server calls the generative AI model using the constructed prompt sentence.
The server sends the prompt sentence to a language-generation engine and configures generation parameters.
Input: the prompt sentence from Step 7 and configuration such as maximum token count and creativity level.
Processing: the server transmits the prompt, the generative AI model processes the prompt using its internal neural network layers, and produces a sequence of tokens representing dialog or response content; the server collects the tokens until a stopping condition is met.
Output: response information or dialog information encoded as one or more text strings representing utterances.

### Step 9:

The server structures the dialog information into turns and roles.
The server analyzes the generated text to separate lines into speaker turns and to annotate metadata.
Input: the plain text output from the generative AI model, which may include markers or implicit turn boundaries.
Processing: the server scans the text for patterns or delimiters, segments the text into individual utterances, assigns speaker roles such as “partner” or “user,” and attaches sequence numbers and time stamps.
Output: a structured dialog record in which each utterance has associated speaker role and position in the sequence.

### Step 10:

The server transmits the structured dialog record to the terminal.
The server encapsulates the dialog record into a response message and sends it across the network.
Input: the structured dialog record generated in Step 9.
Processing: the server serializes the record, attaches identifiers linking it to the profile and session, and sends it using a communication protocol.
Output: a received dialog record at the terminal, ready for presentation.

### Step 11:

The terminal presents the dialog content to the user.
The terminal renders text on the display and optionally converts partner utterances into audio.
Input: the structured dialog record from the server.
Processing: the terminal formats each utterance into a user interface widget, orders them chronologically, and either displays them or feeds them into a text-to-speech engine; the terminal may highlight which lines are suggested for the partner.
Output: visible or audible dialog content that the user can read or listen to.

### Step 12:

The user provides a response to the dialog content.
The user speaks into the microphone or types a reply on the terminal.
Input: the displayed or spoken partner utterance from the terminal.
Processing: the user composes a reply mentally and then either vocalizes it or enters it as text via the user interface.
Output: a user response captured as audio data or text data by the terminal.

### Step 13:

The terminal captures and sends user voice information to the server.
When the user responds verbally, the terminal records audio samples and prepares them for transmission.
Input: analog speech signals from the user's voice detected by the microphone.
Processing: the terminal digitizes the signal, encodes it into an audio format, associates it with current dialog context identifiers, and transmits it over the network to the server.
Output: an audio data stream or file containing user voice information that reaches the server.

### Step 14:

The server performs speech recognition and acoustic feature extraction on the received audio.
The server passes the audio to a voice recognition processing apparatus and receives recognized text and timing.
Input: the audio data stream or file from the terminal.
Processing: the server calls a speech-to-text component which analyzes the waveform using acoustic models and language models to produce a text transcript and timing for words; the server also computes acoustic features such as energy, pitch variation, speaking rate, and silence duration intervals using signal processing routines.
Output: a recognized text sequence and a feature vector time series representing the acoustic characteristics of the user's speech.

### Step 15:

The server estimates an emotional state from the acoustic feature time series.
The server passes the feature time series to an emotion classification model.
Input: the acoustic feature time series extracted in Step 14.
Processing: the server segments the time series into windows, inputs each window into a trained neural classifier, and obtains probability distributions over emotional classes such as “excited,” “calm,” or “nervous”; the server aggregates probabilities over the reply to generate a single predominant emotional state and confidence.
Output: an estimated emotional state label and confidence score associated with the user's reply.

### Step 16:

The terminal captures and sends image information of the user's face to the server.
While the user is responding, the terminal periodically records frames from the camera.
Input: raw image data from the camera showing the user's face region during conversation.
Processing: the terminal captures images at predefined intervals, compresses them into a standard format, annotates them with time stamps and session identifiers, and transmits them to the server.
Output: a sequence of image frames related to the dialog context received at the server.

### Step 17:

The server performs face detection and facial emotion recognition on the image frames.
The server processes each received frame to locate faces and infer facial expressions.
Input: a time-ordered set of image frames containing the user's face.
Processing: the server applies a face detection algorithm to find face bounding boxes, crops face regions, and feeds the cropped images into a facial expression classifier that outputs probabilities for emotions such as happiness, sadness, or surprise; the server associates these probabilities with corresponding time stamps.
Output: a time-aligned facial emotion probability series for the user.

### Step 18:

The server fuses the voice-based and face-based emotional information and computes a conversation activity level.
The server combines multiple emotion sources into a single consistent representation and derives an activity metric.
Input: the acoustic-based emotional state and confidence from Step 15, and the facial emotion probability series from Step 17.
Processing: the server constructs a combined feature vector that includes voice-based probabilities, average facial emotion probabilities, and dialog context metrics such as response length and latency; the server feeds this vector into a fusion model or algorithm that outputs a fused emotional state and an activity level score, for example on a 0 to 1 scale.
Output: a fused emotional state label and a conversation activity level associated with the current segment of dialog.

### Step 19:

The server decides whether to adjust the prompt sentence and dialog generation strategy based on the conversation activity level and fused emotional state.
The server evaluates thresholds and rules for adaptation.
Input: the fused emotional state and the activity level from Step 18, plus the current conversation context including previous prompts.
Processing: the server compares the activity level against predefined ranges, checks emotional state for negative or positive valence, and selects an adaptation policy such as “simplify questions,” “introduce new topics,” or “increase depth;” the server then modifies or regenerates a prompt template accordingly.
Output: an adaptation decision and a new or adjusted prompt sentence capturing the desired change in conversational behavior.

### Step 20:

The server generates a new prompt sentence to steer the generative AI model.
The server constructs a sentence that encodes the adaptation decision and updated instructions.
Input: the adaptation decision and current person profile.
Processing: the server chooses a template variant and rewrites parts of the previous prompt; for instance, if the user appears nervous and the activity level is low, the server may create a prompt such as “The user seems quiet and slightly nervous. Generate two very simple, encouraging questions about the Beatles, avoid deep technical details, and add one short compliment about their music taste.”
Output: an updated prompt sentence that reflects real-time emotional and activity analysis.

### Step 21:

The server calls the generative AI model again using the updated prompt sentence and obtains revised response information.
The server sends the updated prompt and receives new dialog content.
Input: the updated prompt sentence from Step 20 and the current dialog history as conditioning context.
Processing: the server transmits the data to the generative AI model, which generates new token sequences based on both the updated prompt and dialog history; the server collects and structures the output into utterances, similar to Steps 8 and 9.
Output: newly generated response information or dialog information that is tailored to the current emotional state and conversation activity.

### Step 22:

The server generates topic information, advertisement information, or recommendation information based on the dialog information and person profile.
The server uses both generated content and profile data to derive additional guidance or offers.
Input: the structured dialog information from the generative AI model and the person profile with preference labels.
Processing: the server identifies key topics in the dialog content using natural language processing, matches these topics with catalog entries or information sources, and composes topic suggestions, advertisements, or recommendations that align with the user's preferences and current mood.
Output: topic information, advertisement information, or recommendation information formatted as short text items or messages.

### Step 23:

The server transmits the topic information, advertisement information, or recommendation information to the terminal.
The server prepares a response containing assistance information in addition to dialog content.
Input: the generated topic, advertisement, or recommendation items from Step 22.
Processing: the server encapsulates these items in a structured payload, associates them with the current session, and sends them to the terminal over the network.
Output: a received assistance payload at the terminal, containing lists of topics and recommendations.

### Step 24:

The terminal presents the assistance information to the user in coordination with the ongoing dialog.
The terminal displays or plays the additional information in a manner that does not obstruct the main interaction.
Input: the assistance payload received in Step 23 and the current dialog state.
Processing: the terminal arranges the topic information and recommendations in a compact overlay or side panel, optionally prioritizing items based on server-provided scores, and updates the display as new items arrive; the terminal may also read selected items aloud or vibrate to notify the user of new suggestions.
Output: visible or audible assistance cues enabling the user to adjust conversation content or refer to relevant offers in real time.

### Step 25:

The server logs the dialog, emotional states, activity levels, and assistance responses for later analysis and model improvement.
The server writes summary records and detailed traces into persistent storage.
Input: dialog transcripts, fused emotion labels, activity levels, adaptation decisions, and chosen topics or recommendations from previous steps.
Processing: the server structures the data into log entries with standardized fields, compresses or indexes them for efficient retrieval, and stores them in a database or log system; the server may also mark records useful for retraining or fine-tuning models.
Output: a persistent log dataset that can be used to refine models, update templates, and improve future performance of the system.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

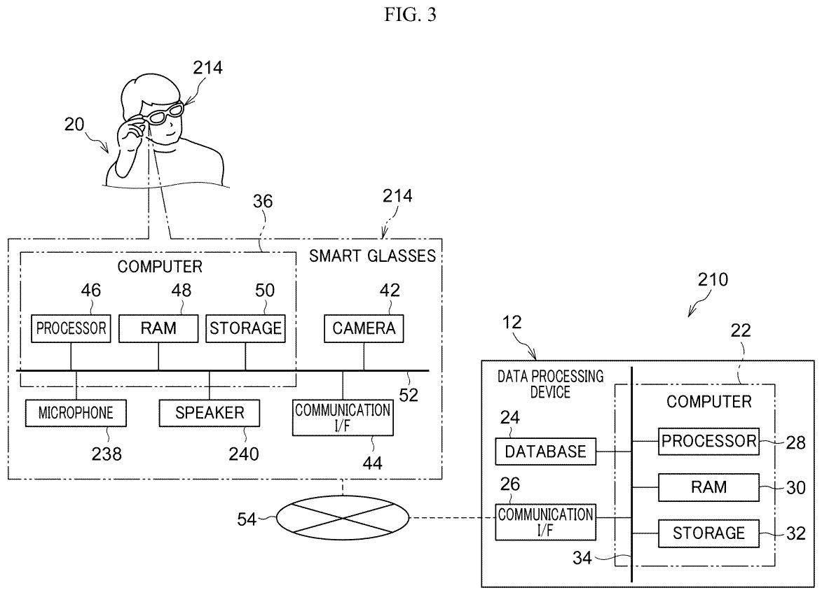

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

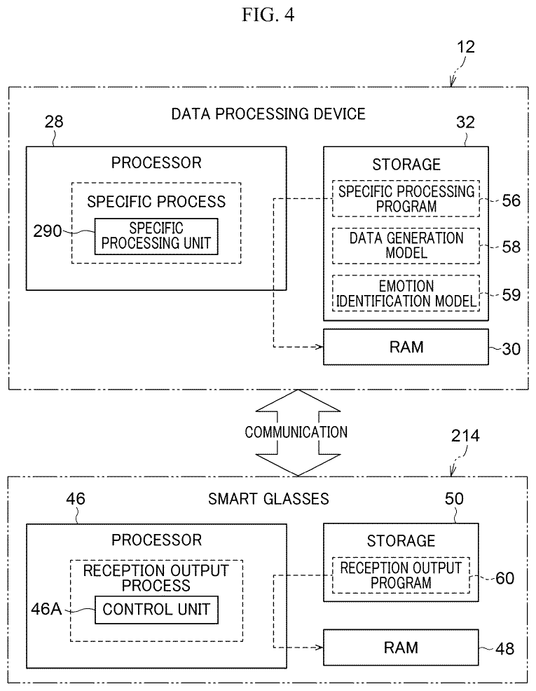

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

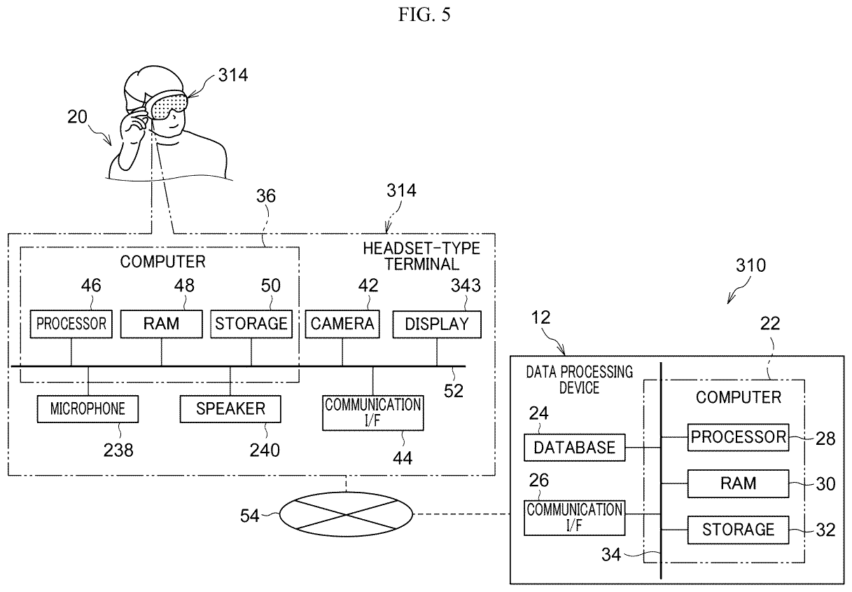

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

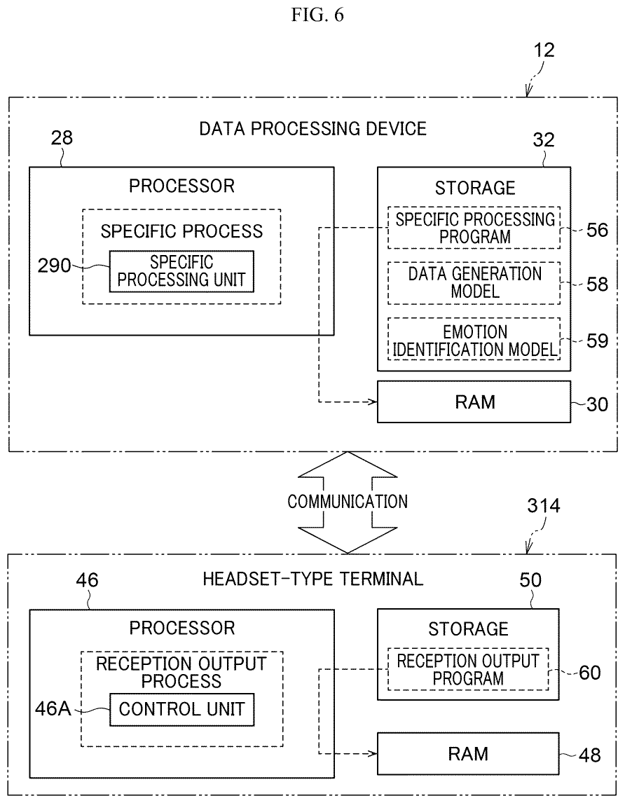

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

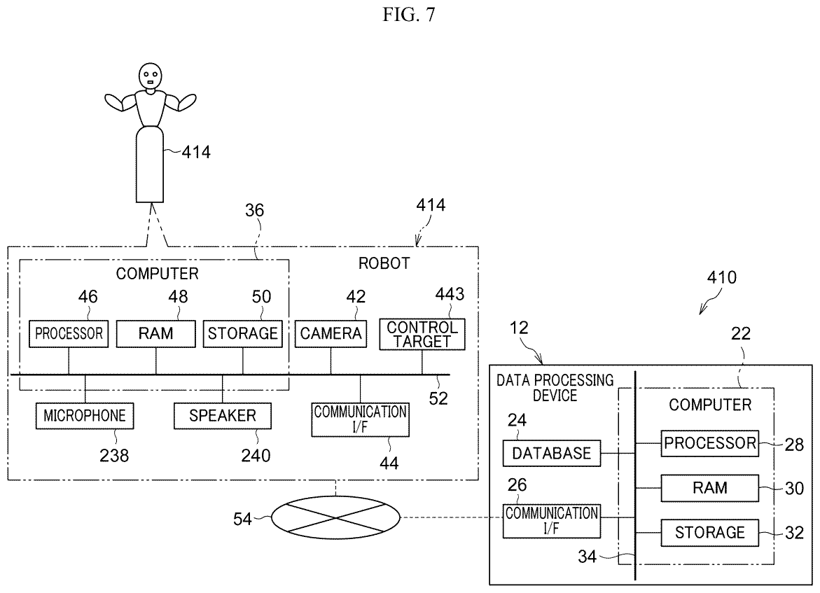

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

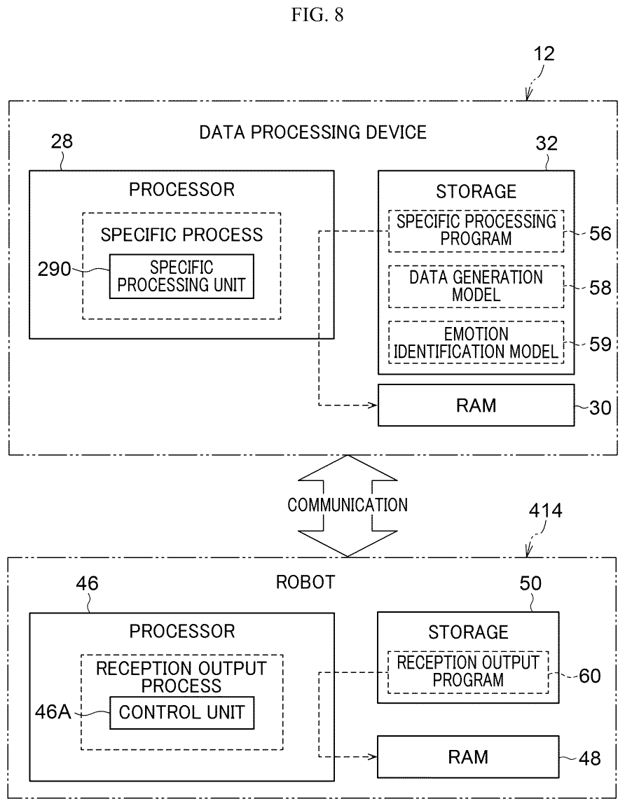

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

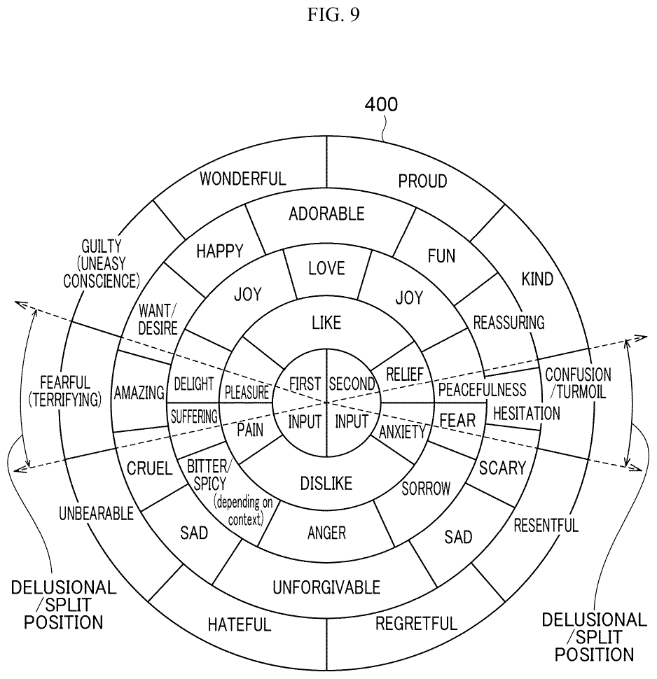

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

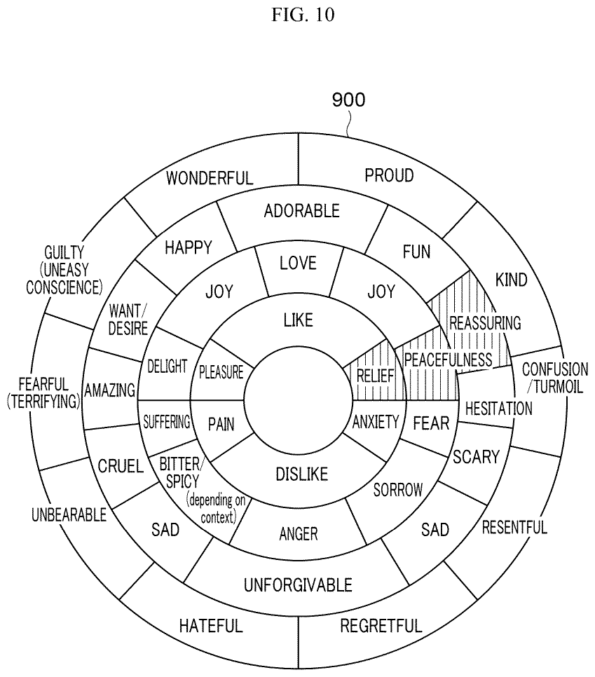

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire attribute information or preference information regarding a conversation counterpart via a user interface including a general input/output device, and store the attribute information or the preference information as structured data,
automatically generate, based on the structured data, a prompt sentence suitable as input to a generative information processing model, the prompt sentence including instruction content for conversation support, an output format, prohibited matters, and a number of topic candidates, using a template, and format the prompt sentence as input data to the generative information processing model,
transmit the formatted prompt sentence to the generative information processing model via a communication function, and obtain response data generated by the generative information processing model based on the prompt sentence,
perform natural language processing on the obtained response data to extract topic candidates, utterance examples, question examples, and conversation-continuation expressions, and convert a result of the natural language processing into conversation support information that is presentable to a user, and
output the conversation support information to the user via a display device or an audio output device.

### Supplementary 2

The system according to supplementary 1,
wherein the processor is configured to
integrate a plurality of pieces of the attribute information or the preference information included in the structured data into a template sentence including an outline description of the conversation counterpart, attitude conditions in the conversation, and output constraint conditions, and generate the prompt sentence that instructs the generative information processing model to generate the topic candidates, the specific question examples corresponding to the respective topic candidates, and the conversation-continuation expressions.

### Supplementary 3

The system according to supplementary 1,
wherein the processor is configured to
divide the response data into tokens, identify text regions corresponding to topic segments, classify each of the text regions based on a topic type, a speech act type, and an expression tone, and generate display data for presenting the conversation support information in a list format or a hierarchical structure format using a classification result.

### Application Example 1

### Supplementary 1

A system comprising a processor and a memory,
wherein the processor is configured to
acquire attribute information and preference information of a person to be met via a user interface, and store the attribute information and the preference information as structured text data in a storage area of a terminal,
receive, at a server, the structured text data transmitted from the terminal, generate, based on the structured text data, a prompt sentence expressed in natural language for a generative AI model, and transmit a generation request including the prompt sentence to the generative AI model,
obtain, at the server, response data including product proposal information generated by the generative AI model based on the prompt sentence, convert the response data into a predetermined data structure, and transmit the response data in the predetermined data structure to the terminal, and
cause the terminal to display, on a visual display device, the product proposal information received from the server in a list format or an itemized format, so that a user can present product information to the person to be met based on the product proposal information.

### Supplementary 2

The system according to supplementary 1,
wherein the processor is configured to convert, at the server, the product proposal information from text data into structured data including a plurality of proposal items, and extract, for each proposal item, name information, classification information, and reason information, and transmit the structured data to the terminal.

### Supplementary 3

The system according to supplementary 1,
wherein the processor is configured to cause the terminal to emphasize or separately display, on a display screen, correspondence between the product proposal information and the attribute information and the preference information, so that the user is able to compare and select different proposal contents for each person to be met.

### Example 2

### Supplementary 1

A system comprising a processor,
wherein the processor is configured to
acquire, via a user interface, information relating to attributes and hobbies of a person whom a user plans to meet, and
perform linguistic processing on the acquired information to execute segmentation processing and removal of unnecessary terms so as to extract search terms, and
acquire related information from an external information source via an information retrieval communication interface based on the extracted search terms, and
convert the acquired related information into feature data and estimate a persona of the person whom the user plans to meet by using trained discrimination processing or classification processing based on the feature data, and
generate a prompt sentence for instructing a generative AI model to generate a response, the prompt sentence being generated based on the acquired information relating to the attributes and hobbies and the estimated persona, and
input the generated prompt sentence into the generative AI model and acquire, from the generative AI model, a response based on the prompt sentence, and
generate presentation information including conversation points or candidate topics for an initial meeting based on the estimated persona and the acquired response, and
output the presentation information to the user in a visual or auditory manner via an output interface.

### Supplementary 2

The system according to supplementary 1,
wherein the processor is configured to
input, into the generative AI model, structured data representing the persona together with the prompt sentence, and acquire, from the generative AI model, a response including a natural-language description of the persona and conversation candidates reflecting the structured data.

### Supplementary 3

The system according to supplementary 1,
wherein the processor is configured to
generate a statistical feature vector based on the acquired related information and output category information relating to interests, behavioral tendencies, or lifestyle of the person whom the user plans to meet by inputting the statistical feature vector into a classifier or a clustering model.

### Application Example 2

### Supplementary 1

A system comprising a processor,
wherein the processor is configured to
acquire, via a user interface, attribute information or preference information regarding a person to be met, and optionally past history information related to a user or a customer, obtain, based on the attribute information or the preference information and the past history information, related information from an information retrieval processing apparatus, and estimate a person profile corresponding to the person to be met,
generate, based on the person profile and the attribute information or the preference information, a prompt sentence that instructs a generative AI model to generate response content or dialog content,
input the prompt sentence to the generative AI model and obtain, from the generative AI model, response information or dialog information based on the prompt sentence,
analyze voice information acquired from the user or the customer by using a voice recognition processing apparatus and estimate an emotional state based on the analyzed voice information,
analyze image information acquired from the user or the customer by using an image recognition processing apparatus and estimate an emotional state based on a facial expression included in the analyzed image information,
integrate the emotional state based on the voice information and the emotional state based on the image information, evaluate a conversation activity level based on a result of the integration, and dynamically adjust content of the prompt sentence or the response information in accordance with an evaluation result of the conversation activity level, and generate topic information, advertisement information, or recommendation information based on the response information or the dialog information, and present the topic information, the advertisement information, or the recommendation information to the user or the customer.

### Supplementary 2

The system according to supplementary 1,
wherein the processor is configured to control generation of the prompt sentence such that the prompt sentence is changed in accordance with the person profile, the emotional state, and the conversation activity level, including at least one of a difficulty level of dialog, a type of question, and a domain of topic, and to generate, from the generative AI model, the response information as a dialog scenario for simulated dialog with the user or for assisting actual dialog with the person to be met.

### Supplementary 3

The system according to supplementary 1,
wherein the processor is configured to analyze the response information or the dialog information by using a natural language processing technique, extract at least one of a common topic, a dialog turning point, and a response tendency of the user, and generate and present feedback information or dialog improvement instruction information for the user based on an extraction result and the emotional state.

What is claimed is:

1. A system comprising:
circuitry configured to:
receive, via a communication interface coupled to a packet-switched network, descriptive data characterizing a target entity, the descriptive data comprising attribute data and preference data;
convert the descriptive data into structured data conforming to a predefined schema by mapping respective fields of the attribute data and the preference data to schema-defined entries;
select, from a plurality of stored templates, a template based on a parameter derived from the structured data, each template comprising fixed text segments and placeholder tokens;
generate a prompt sentence by inserting values from the structured data into the placeholder tokens of the selected template, the prompt sentence encoding instruction content, an output format specification, one or more constraint conditions, and a requested quantity of output segments;
input the prompt sentence into a generative neural network model to cause the generative neural network model to generate response data comprising a text sequence;
apply natural language processing to the response data to segment the text sequence into labeled portions by identifying boundary markers, and classify each labeled portion according to a segment type and a communicative function type; and
generate, based on the classified labeled portions, structured output data formatted for rendering on a terminal device coupled to the packet-switched network.

2. The system according to claim 1, wherein the prompt sentence further encodes an outline description derived from the attribute data, attitude conditions specifying a tone or politeness level for the response data, and output constraint conditions limiting a length or style of the response data.

3. The system according to claim 2, wherein the circuitry is further configured to normalize the attribute data and the preference data by comparing respective text values against a stored dictionary of known categories and assigning a canonical code to each recognized value.

4. The system according to claim 3, wherein classifying each labeled portion comprises assigning a topic type label, a speech act type label indicating whether the labeled portion corresponds to a question, a suggestion, or a statement, and an expression tone label indicating a qualitative characterization of the labeled portion.

5. The system according to claim 4, wherein the structured output data comprises, for each segment, a topic title field, a topic description field, one or more question example fields, and one or more continuation phrase fields, the structured output data being formatted as a hierarchical data object.

6. The system according to claim 5, wherein the circuitry is further configured to perform safety filtering on the structured output data by checking text fields against content rules comprising prohibited term lists and regular expression patterns, and removing or replacing any portion that violates the content rules.

7. The system according to claim 6, wherein the circuitry is further configured to compress the structured output data by removing auxiliary metadata and applying a compression algorithm before transmitting the structured output data to the terminal device via the packet-switched network.

8. The system according to claim 1, wherein the circuitry is further configured to extract search terms from the structured data by performing tokenization and removal of stop-word tokens, and transmit a query comprising the search terms to an external information source via the communication interface.

9. The system according to claim 8, wherein the circuitry is further configured to receive, from the external information source, related information comprising document data, and convert the related information into feature data by computing term frequency-inverse document frequency values for terms appearing in the document data.

10. The system according to claim 9, wherein the circuitry is further configured to input the feature data into a trained classification model comprising a neural network having an input layer, one or more hidden layers with nonlinear activation functions, and an output layer producing probability scores for a plurality of predefined category labels, and assign one or more of the category labels to the target entity based on the probability scores.

11. The system according to claim 10, wherein the prompt sentence is generated based on both the structured data and the assigned category labels, such that the prompt sentence encodes a description of the target entity reflecting both the attribute data and inferred characteristics derived from the category labels.

12. The system according to claim 11, wherein the trained classification model is trained using a training procedure comprising computing a cross-entropy loss between predicted category distributions and ground truth labels, and updating model weights using a gradient-based optimization algorithm, the training procedure further comprising augmenting training data by applying paraphrasing or reordering operations.

13. The system according to claim 1, wherein the circuitry is further configured to receive audio data from a microphone device coupled to the packet-switched network, extract acoustic features from the audio data comprising at least one of energy values, pitch contour data, or speech rate data, and estimate a first emotional state by inputting the acoustic features into a voice emotion classification model.

14. The system according to claim 13, wherein the circuitry is further configured to receive image data from a camera device, detect a face region within the image data using a face detection algorithm, and estimate a second emotional state by inputting the detected face region into a facial expression classification model.

15. The system according to claim 14, wherein the circuitry is further configured to integrate the first emotional state and the second emotional state by constructing a combined feature vector comprising voice-based emotion probability values and face-based emotion probability values, and compute a conversation activity level by inputting the combined feature vector into a fusion model.

16. The system according to claim 15, wherein the circuitry is further configured to dynamically adjust the prompt sentence in accordance with the conversation activity level, such that when the conversation activity level is below a first threshold the prompt sentence is modified to instruct the generative neural network model to generate simplified output segments, and when the conversation activity level is above a second threshold the prompt sentence is modified to instruct the generative neural network model to generate output segments with increased specificity.

17. The system according to claim 16, wherein the descriptive data characterizing the target entity comprises attribute information and hobby information of a person whom a user is scheduled to meet, the structured output data comprises conversation support information including topic candidates, utterance examples, question examples, and conversation-continuation expressions, and the terminal device comprises at least one of a smart device, smart glasses, a headset-type terminal, or a robot.

18. A system comprising:
circuitry configured to:
receive, via a communication interface coupled to a packet-switched network, structured text data representing attribute data and preference data of a target entity, the structured text data conforming to a predefined schema comprising an attribute list field and a preference list field;
select a template from a plurality of stored templates based on a context parameter derived from the structured text data, and generate a prompt sentence by inserting values from the attribute list field and the preference list field into placeholder tokens of the selected template, the prompt sentence encoding instruction content, an output format specification, prohibited content categories, and a requested quantity of output items;
transmit the prompt sentence to a generative neural network model via the communication interface, and receive response data comprising a generated text sequence;
segment the generated text sequence into a plurality of labeled portions by identifying numbering patterns, line break markers, or connective expressions within the generated text sequence;
classify each of the plurality of labeled portions according to a segment type, a speech act type, and an expression tone by applying rule-based classification or a trained classifier model;
extract, from each classified labeled portion, a title field, a description field, one or more question example fields, and one or more continuation phrase fields, and store the extracted fields in a structured record; and
transmit the structured record to a terminal device coupled to the packet-switched network for rendering on a display device of the terminal device.

19. The system according to claim 18, wherein the circuitry is further configured to normalize the extracted fields by truncating text fields exceeding a predetermined length limit, removing repeated sentences, and checking each field against a prohibited word list, and wherein the structured record is compressed before transmission to the terminal device.

20. A method performed by circuitry, the method comprising:
receiving, via a communication interface coupled to a packet-switched network, descriptive data characterizing a target entity, the descriptive data comprising attribute data and preference data;
converting the descriptive data into structured data conforming to a predefined schema by mapping respective fields of the attribute data and the preference data to schema-defined entries;
selecting, from a plurality of stored templates, a template based on a parameter derived from the structured data;
generating a prompt sentence by inserting values from the structured data into placeholder tokens of the selected template, the prompt sentence encoding instruction content, an output format specification, one or more constraint conditions, and a requested quantity of output segments;
inputting the prompt sentence into a generative neural network model to cause the generative neural network model to generate response data comprising a text sequence;
applying natural language processing to the response data to segment the text sequence into labeled portions by identifying boundary markers, and classifying each labeled portion according to a segment type and a communicative function type; and
generating, based on the classified labeled portions, structured output data formatted for rendering on a terminal device coupled to the packet-switched network.
